(19) United States
(12) Patent Application Publication
(10) Pub. No.: US 2024/0365139 A1
(43) Pub. Date: Oct. 31, 2024

(54) METHOD FOR DETERMINING MEASUREMENT PERIOD, TERMINAL DEVICE, CHIP AND STORAGE MEDIUM

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 18/766,192

(22) Filed: Jul. 8, 2024

Related U.S. Application Data
(63) Continuation of application No. PCT/CN2022/070579, filed on Jan. 6, 2022.

(51) Int. Cl. H04W 24/02

(52) U.S. Cl. CPC H04W 24/02

(57) ABSTRACT

A method for determining a measurement period includes: determining, by a terminal device, a measurement period of a first frequency point and/or a first MO based on a first positional relationship; where the first positional relationship includes a positional relationship between at least some MGs of a plurality of configured MGs and measurement timing windows of the first frequency point and/or the first MO, and/or a positional relationship between third MGs of the plurality of MGs that are used to measure the first frequency point and/or the first MO and remaining MGs of the plurality of MGs except the third MGs.

### CROSS-REFERENCE TO RELATED APPLICATION

This application is a Bypass Continuation Application of PCT/CN2022/070579 filed Jan. 6, 2022, which is incorporated herein by reference in its entirety.

### TECHNICAL FIELD

The present application relates to the field of communication, and more specifically, relates to a method for determining a measurement period, a terminal device, a chip, a computer-readable storage medium, a computer program product, and a computer program.

### BACKGROUND

For a wireless mobile communication system, accurate measurement of cell quality and beam quality is the basis for the effective execution of wireless resource management and mobility management. Currently, a terminal device can use only one or two measurement gaps (Measurement Gap, MG) upon performing radio resource management (RRM) measurement or positioning measurement.

In a case where a UE is configured to perform synchronization signal and PBCH block (Synchronization Signal and PBCH Block, SSB) measurements at multiple frequency points or multiple different reference signal measurements, not all signals may not be included in the MG by using only one MG configuration, thus causing some signals to be unmeasured. In order to solve this problem, multiple concurrent and independent MG configurations are introduced in the related technology, and thus, how to determine a measurement period under multiple MG configurations needs to be considered.

### SUMMARY

The embodiments of the preset application provide a method for determining a measurement period, where the method includes:
determining, by a terminal device, a measurement period of a first frequency point and/or a first MO based on a first positional relationship;
where the first positional relationship includes a positional relationship between at least some MGs of a plurality of configured MGs and measurement timing windows of the first frequency point and/or the first MO, and/or a positional relationship between third MGs of the plurality of MGs that are used to measure the first frequency point and/or the first MO and remaining MGs of the plurality of MGs except the third MG.

The embodiments of the preset application further provide a terminal device, where the terminal device includes:
a first processing module, configured to determine a measurement period of a first frequency point and/or a first MO based on a first positional relationship;
where the first positional relationship includes a positional relationship between at least some MGs of a plurality of configured MGs and measurement timing windows of the first frequency point and/or the first MO, and/or a positional relationship between third MGs of the plurality of MGs that are used to measure the first frequency point and/or the first MO and remaining MGs of the plurality of MGs except the third MG.

The embodiments of the preset application further provide a terminal device, where the terminal device includes: a processor and a memory, where the memory is used to store a computer program, and the processor calls and runs the computer program stored in the memory to perform the method provided by any embodiment of the present application.

The embodiments of the preset application further provide a chip, where the chip includes: a processor, configured to call and run a computer program from a memory to enable a device equipped with the chip to perform the method provided by any embodiment of the present application.

The embodiments of the present application further provide a non-transitory computer-readable storage medium, configured to store a computer program, where the computer program enables a computer to perform the method provided by any embodiment of the present application.

The embodiments of the present application further provide a computer program product including computer program instructions, where the computer program instructions enable a computer to perform the method provided by any embodiment of the present application.

The embodiments of the present application further provide a computer program, where the computer program enables a computer to perform the method provided by any embodiment of the present application.

### BRIEF DESCRIPTION OF THE DRAWINGS

FIG. 1 is a schematic diagram of an architecture of a communication system according to an embodiment of the present application.

FIG. 2 is a flowchart of a method for determining a measurement period according to an embodiment of the preset application.

FIG. 3A is a flowchart of a method for determining a measurement period according to another embodiment of the present application.

FIG. 3B is a flowchart of a method for determining a measurement period according to yet another embodiment of the present application.

FIG. 4 is a schematic diagram of a positional relationship between SSB measurement timing configurations (SSB Measurement Timing Configurations, SMTCs) and MGs according to Embodiment 1 of the present application.

FIG. 5A is a schematic diagram of another positional relationship between SMTCs and MGs according to Embodiment 1 of the present application.

FIG. 5B is a schematic diagram of yet another positional relationship between SMTCs and MGs according to Embodiment 1 of the present application.

FIG. 6 is a schematic diagram of yet another positional relationship between SMTCs and MGs according to Embodiment 1 of the present application.

FIG. 7 is a schematic structural block diagram of a terminal device according to an embodiment of the preset application.

FIG. 8 is a schematic structural block diagram of a terminal device according to another embodiment of the preset application.

FIG. 9 is a schematic structural block diagram of a terminal device according to yet another embodiment of the preset application.

FIG. 10 is a schematic block diagram of a communication device according to an embodiment of the present application.

FIG. 11 is a schematic block diagram of a chip according to an embodiment of the present application.

### DETAILED DESCRIPTION

Technical solutions in the embodiments of the present application will be described below with reference to the accompanying drawings in the embodiments of the present application.

Technical solutions according to embodiments of the present application may be applied to various communication systems, such as a global system of mobile communication (Global System of Mobile communication, GSM) system, a code division multiple access (Code Division Multiple Access, CDMA) system, a wideband code division multiple access (Wideband Code Division Multiple Access, WCDMA) system, a general packet radio service (General Packet Radio Service, GPRS), a long term evolution (Long Term Evolution, LTE) system, an advanced long term evolution (Advanced long term evolution, LTE-A) system, a new radio (New Radio, NR) system, an evolution system of the NR system, an LTE-based access to unlicensed spectrum (LTE-based access to unlicensed spectrum, LTE-U) system, an NR-based access to unlicensed spectrum (NR-based access to unlicensed spectrum, NR-U) system, a non-terrestrial networks (Non-Terrestrial Networks, NTN) system, a universal mobile telecommunications system (Universal Mobile Telecommunication System, UMTS), a wireless local area network (Wireless Local Area Networks, WLAN), a wireless fidelity (Wireless Fidelity, WiFi), a 5th-Generation (5th-Generation, 5G) communication system, and other communication systems.

Generally, traditional communication systems support a limited quantity of connections, and are easy to implement. However, with the development of communication technology, mobile communication systems will not only support traditional communication, but also support, for example, device to device (Device to Device, D2D) communication, machine to machine (Machine to Machine, M2M) communication, machine type communication (Machine Type Communication, MTC), vehicle to vehicle (Vehicle to Vehicle, V2V) communication, and vehicle to everything (Vehicle to everything, V2X) communication, and the embodiments of the present application may also be applied to these communication systems.

Optionally, the communication systems in the embodiments of the present application may be applied to a carrier aggregation (Carrier Aggregation, CA) scenario, a dual connectivity (Dual Connectivity, DC) scenario, or a standalone (Standalone, SA) networking scenario.

The embodiments of the present application are described in combination with a network device and a terminal device. The terminal device may also be referred to as a user equipment (User Equipment, UE), an access terminal, a subscriber unit, a subscriber station, a mobile station, a mobile platform, a remote station, a remote terminal, a mobile device, a user terminal, a terminal, a wireless communication device, a user agent or a user apparatus. The terminal device may be a station (STAION, ST) in the WLAN, or may be a cellular phone, a cordless phone, a session initiation protocol (Session Initiation Protocol, SIP) phone, a wireless local loop (Wireless Local Loop, WLL) station, a personal digital assistant (Personal Digital Assistant, PDA) device, a handheld device with a wireless communication function, a computing device or another processing device connected to a wireless modem, a vehicle-mounted device, a wearable device, a terminal device in a next generation communication system (e.g., an NR network), or a terminal device in a future evolved public land mobile network (Public Land Mobile Network, PLMN) network, etc.

In the embodiments of the present application, the terminal device may be deployed on land including indoor or outdoor, handheld, wearable or vehicle-mounted; alternatively, the terminal device may be deployed on water (such as on ships); alternatively, the terminal device may be deployed aerially (such as in airplanes, balloons and satellites).

In the embodiments of the present application, the terminal device may be a mobile phone (Mobile Phone), a pad (Pad), a computer with wireless transceiving function, a virtual reality (Virtual Reality, VR) terminal device, an augmented reality (Augmented Reality, AR) terminal device, a wireless terminal device in industrial control, a wireless terminal device in self driving (self driving), a wireless terminal device in remote medical (remote medical), a wireless terminal device in smart grid (smart grid), a wireless terminal device in transportation safety (transportation safety), a wireless terminal device in smart city (smart city), a wireless terminal device in smart home (smart home), or the like.

As an example rather than a limitation, the terminal device in the embodiments of the present application may be a wearable device. The wearable device may also be referred to as a wearable smart device, which is a general term of wearable devices developed by intelligent design and development on daily wear by applying wearable technology, such as glasses, gloves, watches, clothing and shoes. The wearable device is a portable device that is worn directly on a body, or integrated into clothes or accessories of users. The wearable device is not only a hardware device, but also implements powerful functions through software support as well as data interaction or cloud interaction. Generalized wearable smart devices include devices which are fully functional, have large sizes, and may implement complete or partial functions without relying on smart phones, such as smart watches or smart glasses, and devices (such as various smart bracelets, and smart jewelries for monitoring physical signs) which focus on a certain kind of application functions only and need to be used in conjunction with other devices (such as smart phones).

In the embodiments of the present application, the network device may be a device configured to communicate with a mobile device, such as an access network device. The network device may be an access point (Access Point, AP) in the WLAN, a base transceiver station (Base Transceiver Station, BTS) in GSM or CDMA, a base station (NodeB, NB) in WCDMA, an evolved base station (Evolutional Node B, eNB or eNodeB) in LTE, a relay station, an access point, a vehicle-mounted device, a wearable device, a network device in an NR network, or a network device in the future evolved PLMN network.

The network device may also be a core network device, such as a mobility management entity (Mobility Management Entity, MME), an access and mobility management function (Access and Mobility Management Function, AMF), and other network entities, which are not limited in the embodiments of the present application.

As an example rather than a limitation, the network device in the embodiments of present application may have mobile characteristics. For example, the network device may be a mobile device. Optionally, the network device may be a satellite, or a balloon station. For example, the satellite may be a low earth orbit (low earth orbit, LEO) satellite, a medium earth orbit (medium earth orbit, MEO) satellite, a geostationary earth orbit (geostationary earth orbit, GEO) satellite, a high elliptical orbit (High Elliptical Orbit, HEO) satellite, or the like. Optionally, the network device may be a base station disposed in a position on land, in a water and the like.

In the embodiments of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell (Small cell). The small cells herein may include a metro cell (Metro cell), a micro cell (Micro cell), a pico cell (Pico cell), a femto cell (Femto cell), and the like. These small cells are characterized by a small coverage range and a low transmission power, and are suitable for providing high-speed data transmission service.

The embodiments of present application provide a method for determining a measurement period. The method includes:
determining, by a terminal device, a measurement period of a first frequency point and/or a first MO based on a first positional relationship;
where the first positional relationship includes a positional relationship between at least some MGs of a plurality of MGs that are configured and measurement timing windows of the first frequency point and/or the first MO, and/or a positional relationship between third MGs of the plurality of MGs that are used to measure the first frequency point and/or the first MO and remaining MGs of the plurality of MGs except the third MGs.

In some embodiments, the determining, by the terminal device, the measurement period of the first frequency point and/or the first MO based on the first positional relationship includes:
determining, by the terminal device, the measurement period of the first frequency point and/or the first MO based on the positional relationship between the at least some MGs of the plurality of MGs and the measurement timing windows of the first frequency point and/or the first MO in response that MGs are not required to be used in a measurement of the first frequency point and/or the first MO.

In some embodiments, in a case where MGs associated with the first frequency point and/or the first MO are not configured, the at least some MGs include each MG of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the plurality of MGs in a case where none of the measurement timing windows of the first frequency point and/or the first MO are overlapped by respective MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within first MGs of the plurality of MGs in a case where all of the measurement timing windows of the first frequency point and/or the first MO are overlapped by the first MGs and not overlapped by second MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within first MGs of the plurality of MGs or relevant parameters for measurement conducted outside first MGs in a case where part of the measurement timing windows of the first frequency point and/or the first MO are overlapped by the first MGs and none of the measurement timing windows of the first frequency point and/or the first MO are overlapped by second MGs of the plurality of MGs.

In some embodiments, a first scaling factor in the relevant parameters for measurement conducted within the first MGs is determined based on a period of the first MGs.

In some embodiments, a first scaling factor in the relevant parameters for measurement conducted outside the first MGs is determined based on a period of the first MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the first MGs of the plurality of MGs and/or relevant parameters for measurement conducted outside second MGs in response that priorities of the plurality of MGs are uncertain or the same, in a case where all of the measurement timing windows of the first frequency point and/or the first MO are overlapped by the first MGs and part of the measurement timing windows of the first frequency point and/or the first MO are overlapped by the second MGs of the plurality of MGs.

In some embodiments, the determining, by the terminal device, the measurement period of the first frequency point and/or the first MO based on the relevant parameters for measurement conducted within the first MGs and/or the relevant parameters for measurement conducted outside the second MGs includes:
determining, by the terminal device, the measurement period of the first frequency point and/or the first MO based on a maximum value or a minimum value of a first measurement period and a second measurement period; where the first measurement period is determined based on the relevant parameters for measurement conducted within the first MGs, and the second measurement period is determined based on the relevant parameters for measurement conducted outside the second MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within first MGs of the plurality of MGs in response that a priority of the first MGs is higher than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a third measurement period and a fourth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs of the plurality of MGs;
where the third measurement period is determined based on relevant parameters for measurement conducted within the first MGs, and the fourth measurement period is determined based on relevant parameters for measurement conducted within the second MGs.

In some embodiments, the first scaling factor in the relevant parameters for measurement conducted within the first MGs is a preset value or determined based on a period of the second MGs.

In some embodiments, the first scaling factor in the relevant parameters for measurement conducted within the second MGs is a preset value or determined based on a period of the second MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a fifth measurement period and a sixth measurement period in response that a priority of the first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs of the plurality of MGs;
where the fifth measurement period is determined based on relevant parameters for measurement conducted within the first MGs, and the sixth measurement period is determined based on relevant parameters for measurement conducted outside the second MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a seventh measurement period and an eighth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs of the plurality of MGs;
where the seventh measurement period is determined based on relevant parameters for measurement conducted outside the first MGs, and the eighth measurement period is determined based on relevant parameters for measurement conducted outside the second MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a ninth measurement period and a tenth measurement period or a sum of the ninth measurement period and the tenth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs of the plurality of MGs;
where the ninth measurement period is determined based on relevant parameters for measurement conducted outside the first MGs and the first ratio corresponding to the first MGs, and the tenth measurement period is determined based on relevant parameters for measurement conducted outside the second MGs and a second ratio corresponding to the second MGs.

In some embodiments, the first ratio and the second ratio are determined based on the relevant parameters for measurement conducted outside the first MGs and the relevant parameters for measurement conducted outside the second MGs.

In some embodiments, the first ratio and the second ratio are determined based on a first sharing factor configured by a network device.

In some embodiments, the determining, by the terminal device, the measurement period of the first frequency point and/or the first MO, according to the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the plurality of MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

In some embodiments, the first scaling factor in the relevant parameters for measurement conducted outside the plurality of MGs is determined based on a positional relationship between the plurality of MGs.

In some embodiments, in a case where the plurality of MGs does not overlap with each other, the first scaling factor is determined based on periods of the respective MGs.

In some embodiments, in a case where the plurality of MGs overlaps, the first scaling factor is determined based on a minimum value in periods of the respective MGs.

In some embodiments, determining, by the terminal device, the measurement period of the first frequency point and/or the first MO based on the relevant parameters for measurement conducted outside the plurality of MGs includes:
determining, by the terminal device, the measurement period of the first frequency point and/or the first MO based on the relevant parameters for measurement conducted outside the plurality of MGs in a case where priorities of the plurality of MGs are uncertain or the priorities of the plurality of MGs are different or the same.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

In some embodiments, the third MGs are determined based on a preset rule or priorities of the respective MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within respective MGs of the plurality of MGs in a case where part of the measurement timing windows of the first frequency point and/or the first MO are overlapped by respective MGs of the plurality of MGs, and the measurement timing windows do not include a part of measurement timing windows that are not overlapped by any one of the plurality of MGs.

In some embodiments, the determining, by the terminal device, the measurement period of the first frequency point and/or the first MO based on the relevant parameters for measurement conducted within the respective MGs of the plurality of MGs includes:
determining, by the terminal device, the measurement period of the first frequency point and/or the first MO based on a maximum value or a minimum value of CSSFs for measurement conducted within the respective MGs of the plurality of MGs.

In some embodiments, the determining, by the terminal device, the measurement period of the first frequency point and/or the first MO based on the relevant parameters for measurement conducted within the respective MGs of the plurality of MGs includes:
determining, by the terminal device, measurement periods corresponding to the respective MGs of the plurality of MGs based on relevant parameters for measurement conducted within the respective MGs;
determining, by the terminal device, the measurement period of the first frequency point and/or the first MO based on a maximum value or a minimum value of the measurement periods corresponding to the respective MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows do not include a part of measurement timing windows that are not overlapped by any one of the plurality of MGs.

In some embodiments, the third MGs are determined based on a preset rule or priorities of the respective MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on CSSFs corresponding to measurements conducted within respective MGs of the plurality of MGs in a case where all of the measurement timing windows of the first frequency point and/or the first MO are overlapped by the respective MGs of the plurality of MGs.

In some embodiments, the determining, by the terminal device, the measurement period of the first frequency point and/or the first MO based on the CSSFs corresponding to measurements conducted within the respective MGs of the plurality of MGs includes:
determining, by the terminal device, the measurement period of the first frequency point and/or the first MO based on a maximum value or a minimum value of the CSSFs corresponding to measurements conducted within the respective MGs of the plurality of MGs.

In some embodiments, the determining, by the terminal device, the measurement period of the first frequency point and/or the first MO based on the CSSFs corresponding to measurements conducted within the respective MGs of the plurality of MGs includes:
determining, by the terminal device, second scaling factors corresponding to the respective MGs of the plurality of MGs, based on the CSSFs corresponding to measurements conducted within the respective MGs of the plurality of MGs and second sharing factors corresponding to the respective MGs of the plurality of MGs;
determining, by the terminal device, the measurement period of second the first frequency point and/or the first MO based on a maximum value or a minimum value of the second scaling factors corresponding to the respective MGs of the plurality of MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, third MGs used to measure the first frequency point and/or the first MO, of the plurality of MGs and determining, by the terminal device, the measurement period of the first frequency point and/or the first MO based on relevant parameters for measurement conducted within the third MGs in a case where all of the measurement timing windows of the first frequency point and/or the first MO are overlapped by the respective MGs of the plurality of MGs.

In some embodiments, the third MGs are determined based on a preset rule or priorities of the respective MGs of the plurality of MGs.

In some embodiments, the at least some MGs include fourth MGs configured by a network device and associated with the first frequency point and/or the first MO.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the fourth MGs in a case where none of the measurement timing windows of the first frequency point and/or the first MO are overlapped by the fourth MGs.

In some embodiments, in a case where none of the measurement timing windows are overlapped by remaining MGs of the plurality of MGs except the fourth MGs, a first scaling factor in the relevant parameters for measurement conducted outside the fourth MGs is a preset value.

In some embodiments, in a case where part of the measurement timing windows are overlapped by remaining MGs of the plurality of MGs except the fourth MGs, a first scaling factor in the relevant parameters for measurement conducted outside the fourth MGs is determined based on periods of the remaining MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the fourth MGs in a case where all of the measurement timing windows of the first frequency point and/or the first MO are overlapped by the fourth MGs.

In some embodiments, in a case where the fourth MGs do not overlap with remaining MGs of the plurality of MGs except the fourth MGs, a first scaling factor in the relevant parameters for measurement conducted within the fourth MGs is a preset value.

In some embodiments, determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs in response that a priority of the fourth MGs is higher than priorities of the remaining MGs of the plurality of MGs except the fourth MGs, in a case where the fourth MGs overlap with the remaining MGs.

In some embodiments, determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs and a third scaling factor in response that a priority of the fourth MGs is lower than priorities of remaining MGs of the plurality of MGs except the fourth MGs, in a case where the fourth MGs overlap with the remaining MGs, where the third scaling factor is determined based on ratios between periods of the remaining MGs and a period of the fourth MGs.

In some embodiments, determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs and a fourth scaling factor in a case where the fourth MGs overlap with remaining MGs of the plurality of MGs except the fourth MGs; where the fourth scaling factor is determined based on a sharing ratio configured by a network device.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the fourth MGs in a case where part of the measurement timing windows of the first frequency point and/or the first MO are overlapped by the fourth MGs.

In some embodiments, in a case where none of the measurement timing windows are overlapped by remaining MGs of the plurality of MGs except the fourth MGs, a first scaling factor in the relevant parameters for measurement conducted outside the fourth MGs is determined based on a period of the first MGs.

In some embodiments, in a case where part of the measurement timing windows are overlapped by the remaining MGs of the plurality of MGs except the fourth MGs, a first scaling factor in the relevant parameters for measurement conducted outside the fourth MGs is determined according to a positional relationship between the fourth MGs and the remaining MGs.

In some embodiments, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the fourth MGs in a case where part of the measurement timing windows of the first frequency point and/or the first MO are overlapped by the fourth MGs.

In some embodiments, in a case where the fourth MGs do not overlap with remaining MGs of the plurality of MGs except the fourth MGs, a first scaling factor in the relevant parameters for measurement conducted within the fourth MGs is a preset value.

In some embodiments, in a case where the fourth MGs overlap with remaining MGs of the plurality of MGs except the fourth MGs, if a priority of the fourth MGs is higher than priorities of the remaining MGs, a first scaling factor in the relevant parameters for measurement conducted within the fourth MGs is determined based on a period of the fourth MGs.

In some embodiments, determining, by the terminal device, the measurement period of the first frequency point and/or the first MO based on the relevant parameters for measurement conducted within the fourth MGs includes:
determining, by the terminal device, the measurement period of the first frequency point and/or the first MO based on a third scaling factor and relevant parameters for measurement conducted within the fourth MGs in response that a priority of the fourth MGs is less than priorities of the remaining MGs, in a case where the fourth MGs overlap with the remaining MGs; where the third scaling factor is determined based on ratios between periods of the remaining MGs and a period of the fourth MGs, and a first scaling factor in the relevant parameters for measurement conducted within the fourth MGs is determined based on the period of the fourth MGs.

In some embodiments, determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs and a fourth scaling factor in a case where the fourth MGs overlap with remaining MGs of the plurality of MGs except the fourth MGs; where the fourth scaling factor is determined based on a sharing ratio configured by a network device.

In some embodiments, the determining, by the terminal device, the measurement period of the first frequency point and/or the first MO based on the first positional relationship includes:
determining, by the terminal device, the measurement period of the first frequency point and/or the first MO based on the positional relationship between the third MGs and remaining MGs of the plurality of MGs except the third MGs in response that MGs are required to be used in a measurement of the first frequency point and/or the first MO.

In some embodiments, the third MGs are determined based on periods of respective MGs of the plurality of MGs, a quantity of frequency points and/or MOs associated with the respective MGs, priorities of the respective MGs, a third sharing factor of the respective MGs, or a positional relationship between the respective MGs and the measurement timing windows.

In some embodiments, the third MGs are MGs configured by a network device and associated with the first frequency point and/or the first MO.

In some embodiments, the determining, by the terminal device, the measurement period of the first frequency point and/or the first MO based on the positional relationship between the third MGs and remaining MGs of the plurality of MGs except the third MGs includes:
determining, by the terminal device, the measurement period of the first frequency point and/or the first MO based on relevant parameters for measurement conducted within the third MGs in a case where the third MGs do not overlap with the remaining MGs.

In some embodiments, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on relevant parameters for measurement conducted within the third MGs in response that a priority of the third MGs is higher than priorities of the remaining MGs, in a case where the third MGs overlap with the remaining MGs.

In some embodiments, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on a fifth scaling factor and relevant parameters for measurement conducted within the third MGs in response that a priority of the third MGs is lower than priorities of the remaining MGs, in a case where the third MGs overlap with the remaining MGs; where the fifth scaling factor is determined based on ratios between periods of the remaining MGs and a period of the third MGs.

In some embodiments, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on relevant parameters for measurement conducted within the third MGs and a sixth scaling factor in a case where the third MGs overlap with the other MGs; where the sixth scaling factor is determined based on a sharing ratio of the network device configuration.

In some embodiments, the method further includes:
determining, by the terminal device, measurement periods corresponding to respective MGs of the plurality of MGs based on relevant parameters for measurement conducted within the respective MGs in response that MGs are required to be used in a measurement of the first frequency point and/or the first MO;
determining, by the terminal device, the measurement period of the first frequency point and/or the first MO based on a maximum value or a minimum value of the measurement periods corresponding to the respective MGs of the plurality of MGs.

In some embodiments, for each MG of the plurality of MGs, a CSSF for measurement conducted within the MGs is related to at least one of:
a frequency point and/or an MO associated with the MGs; or
a frequency point and/or an MO whose measurement periods are determined based on relevant parameters for measurement conducted within the MGs.

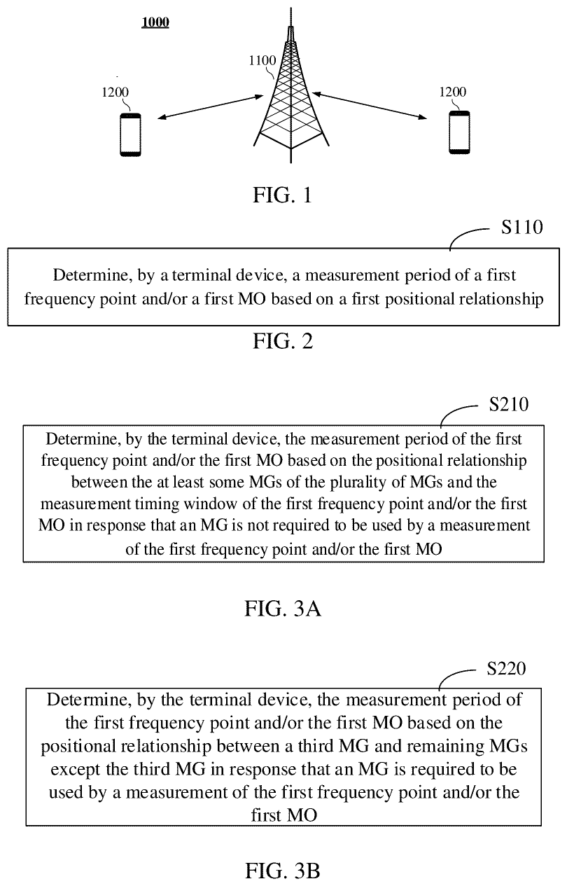

FIG. 1 schematically illustrates a radio access system 1000 including one network device 1100 and two terminal devices 1200. Optionally, the radio communication system 1000 may include multiple network devices 1100, and there may be other quantities of terminal devices within a coverage area of each network device 1100.

It should be understood that devices with communication functions in the network/system in the embodiments of the present application can be called communication devices. Taking the communication system shown in FIG. 1 as an example, the communication devices may include a network device with a communication function and a terminal device with a communication function. The network device and the terminal device may be the specific devices in the embodiments of the present application.

It should be understood that the terms “system” and “network” are often used interchangeably herein. The term “and/or” herein refers to an association relationship describing associated objects, which indicates that there may be three kinds of relationships. For example, “A and/or B” may indicate three cases that: A exists alone, both A and B exist, and B exists alone. The character “/” herein generally indicates that associated objects before and after this character have an “or” relationship.

It should be understood that “indication” involved in embodiments of the present application may be a direct indication, may be an indirect indication, or may represent an association relationship. For example, A indicating B may mean that A indicates B directly, for example, B can be acquired through A; or A indicating B may mean that A indicates B indirectly, for example, A indicates C, and B can be acquired through C; or A indicating B may mean that there is an association relationship between A and B.

In the description of the embodiments of the present application, the term “correspond” may mean that there is a direct corresponding relationship or an indirect corresponding relationship between two parties, or mean that there is an association relationship between two parties, or mean a relationship such as indicating and being indicated, or configuring and being configured.

In order to facilitate the understanding of the technical solutions of the embodiments of the present application, related technologies involved in the embodiments of the present application will be described in the following. The following relevant technologies, as optional solutions, can be arbitrarily combined with the technical solutions of the embodiments of the present application, and these combined solutions all fall within the protection scope of the embodiments of the present application.

### (1) Multiple Concurrent and Independent MG (Also Called “Gap”) Configurations (e.g., Multiple Concurrent and Independent MG Patterns)

In related technologies, a UE can only use one or two MG configurations, i.e., a measurement gap pattern (MG Pattern, MGP) upon performing RRM/positioning measurement. Depending on the UE capability, if a gap of per Frequency Range (per-FR gap) is supported, one MGP can be configured on each of the frequency bands FR1 and FR2, and if a gap of per User Equipment (per-UE gap) is supported, only one MGP can be configured.

When the UE is configured to perform SSB measurements at multiple frequency points (different frequency points correspond to different SSB measurement timing configurations (SSB Measurement Timing Configuration, SMTC)) or multiple different reference signals (such as SSB, channel state information reference signal (Channel State Information Reference Signal, CSI-RS), positioning reference signal (Positioning Reference Signal, PRS), etc.) measurements, not all the signals may be contained in the MG by using only one MGP configuration, resulting in some signals not being accurately measured, or wasting MG.

In order to solve this problem, multiple concurrent and independent MGPs are introduced in the 5G enhanced version to facilitate to be capable of completing the measurement work better under different SMTC configurations, and/or different reference signals, and/or different radio access types (Radio Access Type, RAT)) such as E-UTRA, NR, etc. That is, one direction of MG enhancement is to configure multiple MGPs to measure reference signals from different cells (the period and time domain offset may be different, and thus, may not be measured by one MGP).

When multiple concurrent MGs are configured, problems such as the association between the MG and the frequency point/MO to be measured, and conflicts between multiple MGs need to be considered. In the related technologies, the association between the MG and the frequency point/MO can be configured by RRC signaling. One frequency point/MO can only be associated with one MG, and one MG can be associated with multiple identical or different frequency points/MO. A solution of a priority or gap sharing (gap sharing) can be used to resolve conflicts between multiple MGs in time domain. In a case where two types of MGs do not coincide at all, some specific business scenarios are considered, and therefore, gap cancel (gap cancel) rules may also be used to cancel certain gaps.

### (2) RRM Measurement in RRC Connected State (RRC Connected State)

RRM measurement in an RRC connected state includes intra-frequency measurement and inter-frequency measurement, and taking SSB-based measurement as an example, the network will configure the measurement timing to configure SMTC. The SMTC period is mainly considered when calculating the measurement period upon measuring outside the MG (without MG); measurement conducted within MG (with MG) needs to consider SMTC and measurement gap repetition period (Measurement Gap Repetition Period, MGRP). If it is CSI-RS measurement, currently corresponding duration measurement configuration (such as CMTC) has not been introduced. Therefore, the measurement period is calculated according to the transmission period of the reference signal (CSI-RS). Correspondingly, upon determining the overlapping relationship with the MG, the CSI-RS is also used to determine the overlapping relationship with the MG.

For layer 3 (L3) RRM measurement, the current protocol uses the following rules to determine whether an MG is required for measurement:
for Intra-frequency SSB (Intra-frequency SSB), when the UE indicates no-gap (allowing measurement without MG) through network signaling (such as intraFreq-needForGap), or when the SSB is within current active bandwidth part (Bandwidth Part, BWP) of the UE, or the current downlink (Downlink, DL) BWP is the initial downlink BWP (initial DL BWP), the UE has the ability to perform intra-frequency SSB measurements without the need for an MG (outside MG). Further, according to the relationship between the SMTC and the MG, it can be determined whether the actual measurement (the calculation method of the actual carrier measurement time scaling factor (Carrier Specific Scaling Factor, CSSF)) is within the MG.

MO for intra-frequency SSB and that does not require MG:
when none of its associated SMTCs are overlapped by the MG occasions, the CSSF is calculated by measuring using the outside MG method;
when part of its associated SMTCs are overlapped by the MG occasions, the CSSF is calculated using the outside MG method;
when all of its associated SMTCs are overlapped by the MG occasions, the CSSF is calculated by measuring using the within MG method.

MO for intra-frequency SSB and requiring MG, CSSF can only be calculated within MG method (the relationship between SMTC and MG is no longer considered).

For an inter-frequency SSB (Inter-frequency SSB), if the UE supports inter-frequency measurement using no-gap (interFrequencyMeas-Nogap-r16 capability), the network indicates that inter-frequency measurement does not require an MG (interFrequencyConfig-NoGap-r16), and the inter-frequency SSB is located within an active BWP, the UE has the ability to use outside MG to perform inter-frequency measurement on the SSB at this frequency. Furthermore, according to the relationship between SMTC and MG, it can be determined whether the actual measurement needs to be within the MG.

MO for inter-frequency SSB and that does not require MG:
when none of its associated SMTCs coincide with the MG occasions, the CSSF is calculated using the outside MG method;
when part of its associated SMTCs are overlapped by the MG occasions, the CSSF is calculated using the outside MG method;
when all of its associated SMTCs coincide with the MG occasions, the CSSF is calculated using the within MG method.

MO for inter-frequency SSB and requiring MG, CSSF can only be calculated by using the within MG method.

Taking the detection time of the primary synchronization signal (Primary Synchronization Signal, PSS)/secondary synchronization signal (Secondary Synchronization Signal, SSS) in the cell identification (cell identification) process during FR1 frequency band intra-frequency measurement as an example, the specific measurement period is shown in the following Table 1. The calculation of other durations needed in the measurement process is similar, and the way of calculation is basically: measurement period/measurement period=quantity of sampling points Nsample×basic time unit×CSSF. The basic time unit is the SMTC period (SMTC period) or MGRP or DRX cycle (DRX cycle), the quantity of sampling points may be a preset value, for example, in Tables 1 and 2 below, the quantity of sampling points is 5.

1. Intra-frequency measurement outside MG

TABLE 1
PSS/SSS measurement period [Frequency
Range (Frequency Range, FR) is FR1]

| | |
|---|---|
| DRX cycle | PSS/SSS intra-frequency measurement period |
| | T_{PSS/SSS}_{_{—}}_{sync}_{_{—}}ᵢₙₜᵣₐ |
| No DRX | max(600 ms, ceil(5 × Kₚ) × SMTC |
| | period)^{Note 1} × CSSFᵢₙₜᵣₐ, where ceil |
| | represents rounding up |
| DRX cycle ≤320 ms | max(600 ms, ceil(M2 ^{Note 2} × 5 × Kₚ) × |
| | max(SMTC period, DRX cycle)) × CSSFᵢₙₜᵣₐ |
| DRX cycle >320 ms | ceil(5 × Kₚ) × DRX cycle × CSSFᵢₙₜᵣₐ |

^{NOTE 1}:
If different SMTC periods are configured for different cells, the SMTC period in the requirement is a period used by the cell being identified
^{NOTE 2}:
When highSpeedMeasFlag-r16 is not configured, M2 = 1.5; When highSpeedMeasFlag-r16 is configured, M2 = 1.5 if SMTC periodicity >40 ms; otherwise M2 = 1.
NOTE 3:
When highSpeedMeasFlag-r16 is configured, the above requirements apply only to measurements of the primary carrier and do not apply to measurements of a secondary carrier of active SCell.

CSSFᵢₙₜᵣₐ for the intra-frequency measurement has the following two cases. Sometimes, CSSFᵢₙₜᵣₐ may be calculated using the outside MG method, and sometimes CSSFᵢₙₜᵣₐ may be calculated using the within MG method.

(1) CSSFᵢₙₜᵣₐ is a scaling factor determined based on CSSF_{outside_gap, i} in the protocol when measurements are made outside the MG, for example, when the intra-frequency SMTCs and MGs do not coincide or partially coincide.

(2) CSSFᵢₙₜᵣₐ is a scaling factor determined based on CSSF_{within_gap, i} in the protocol when measurements are made in the MG, for example, when all the intra-frequency SMTC are overlapped by the MGs.

Kₚ is a scaling factor when the overlapping between SMTC and MG in the time domain is taken into account. The value is determined as follows:
(1) when the intra-frequency SMTCs are not overlapped by MGs or all of them are overlapped by the MGs, Kₚ=1;
(2) when part of the intra-frequency SMTCs are overlapped by MGs, Kₚ=1/(1−(SMTC period/MGRP)), where SMTC period<MGRP.

That is, Kₚ takes a value of 1 under normal circumstances. Only when part of the SMTCs are overlapped by MGs (in this case, it is measured outside the MG), the part of the SMTCs that fall within MGs will be removed.

2. Intra-frequency measurement within MG

TABLE 2
PSS/SSS detection time (frequency band range is FR1)

| | |
|---|---|
| DRX cycle | PSS/SSS intra-frequency measurement period |
| | T_{PSS/SSS}_{_{—}}_{sync}_{_{—}}ᵢₙₜᵣₐ |
| No DRX | max(600 ms, 5 × max(MGRP, SMTC period)) × |
| | CSSFᵢₙₜᵣₐ |
| DRX cycle ≤320 ms | max(600 ms, ceil(M2^{Note 1} × 5) × max(MGRP, |
| | SMTC period, DRX cycle)) × CSSFᵢₙₜᵣₐ |
| DRX cycle >320 ms | 5 × max(MGRP, DRX cycle) × CSSFᵢₙₜᵣₐ |

^{NOTE 1}:
When highSpeedMeasFlag-r16 is not configured, M2 = 1.5; When highSpeedMeasFlag-r16 is configured, M2 = 1.5 if SMTC periodicity >40 ms, otherwise M2 = 1.
NOTE 2:
When highSpeedMeasFlag-r16 is configured, the above requirements apply only to measurements of the primary carrier and do not apply to measurements of a secondary carrier of active SCell.

CSSFᵢₙₜᵣₐ of the intra-frequency measurement in Table 2 is a scaling factor determined according to the CSSF_{within_gap, i} in the protocol when the measurement is performed within MGs, for example, when all of the intra-frequency SMTCs are overlapped by MGs.

An MO that initially requires MG to be measured can only be measured in MG, and thus, the CSSF can only be calculated according to the CSSF_{within_gap, i} corresponding to the measurement in MG.

(3) Calculation of CSSF

As explained previously, CSSF is mainly divided into two categories: CSSF_{within_gap, i} and CSSF_{outside_gap, i} based on whether the measurement is conducted within MG. Specifically, CSSF can be calculated separately according to different terminal working scenarios, such as SA, EN-DC (EUTRA-NR Dual Connection, LTE and NR dual connection), NR-DC (NR dual connection), etc. Herein, take a simple SA scenario as an example to illustrate:
the calculation of CSSF for measurement conducted outside MGs (outside gap) will consider the quantity of different service carriers and the quantity of inter-frequency MOs;
the calculation of CSSF for measurement conducted within MGs (within gap) will consider the quantity of all MOs to be measured that fall in the MG position. Optionally, the CSSF for an intra-frequency MO and the CSSF for an inter-frequency MO is further determined according to the gap sharing ratio indicated by the network.

1. In SA scenarios, CSSF_{outside_gap, i} calculation of outside gap

The calculation of CSSF for outside gap is mainly related to the quantity of carriers and the quantity of inter-frequency MOs. The CSSF on the primary carrier component (Primary Carrier Component, PCC) should be determined based on the quantity of PCCs. The CSSF on the secondary carrier component (Secondary Carrier Component, SCC) should be determined according to the quantity of SCCs and the quantity of inter-frequency MOs, as shown in Table 3:

TABLE 3
CSSF_{outside}_{_{—}}_{gap, i} of UE under the SA mode

| | | | | CSSF_{outside}_{_{—}}_{gap, i} | CSSF_{outside}_{_{—}}_{gap, i} | CSSF_{outside}_{_{—}}_{gap, i} |
|---|---|---|---|---|---|---|
| | | | | for FR2 SCC, | for FR2 SCC, | for inter- |
| | | | | where | where | frequency |
| | | | | neighbour | neighbour cell | MO for |
| | | | | cell | measurement | measurement |
| | CSSF_{outside}_{_{—}}_{gap, i} | CSSF_{outside}_{_{—}}_{gap, i} | CSSF_{outside}_{_{—}}_{gap, i} | measurement | is not | conducted |
| Scenario | for FR1 PCC | for FR1 SCC | for FR2 PCC | is required | required | outside MG |
| FR1 only | 1 + | N_{SCC}_{_{—}}_{SSB} + | N/A | N/A | N/A | N_{SCC}_{_{—}}_{SSB} + |
| CA | N_{PCC}_{_{—}}_{CSIRS} | Y + 2x | | | | Y + 2x |
| | | N_{SCC}_{_{—}}_{CSIRS} | | | | N_{SCC}_{_{—}}_{CSIRS} |
| FR2 only | N/A (not | N/A | 1 + | N/A | N_{SCC}_{_{—}}_{SSB} + | N_{SCC}_{_{—}}_{SSB} + |
| intra | applicable) | | N_{PCC}_{_{—}}_{CSIRS} | | Y + 2x | Y + 2x |
| band CA | | | | | N_{SCC}_{_{—}}_{CSIRS} | N_{SCC}_{_{—}}_{CSIRS} |
| FR2 only | N/A | N/A | 1 | 2*(1 + | 2 × | 2 × |
| inter | | | | N_{SCC}_{_{—}}_{CSIRS}_{_{—}}_{FR2}_{_{—}}_{NCM}) | (N_{SCC}_{_{—}}_{SSB} + | (N_{SCC}_{_{—}}_{SSB} + |
| band CA | | | | ^{Note 3,5} | Y + 2x | Y + 2x |
| | | | | | N_{SCC}_{_{—}}_{CSIRS} − | N_{SCC}_{_{—}}_{CSIRS} − |
| | | | | | 1 − | 1 − |
| | | | | | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| FR1 + | 1 + | 2 × (N_{SCC}_{_{—}}_{SSB} + | N/A | 2x(1 + | 2 × (N_{SCC}_{_{—}}_{SSB} + | 2 × (N_{SCC}_{_{—}}_{SSB} + |
| FR2 CA | N_{PCC}_{_{—}}_{CSIRS} | Y + 2* | | N_{SCC}_{_{—}}_{CSIRS}_{_{—}}_{FR2}_{_{—}}_{NCM}) | Y + 2x | Y + 2x |
| (FR1 | | N_{SCC}_{_{—}}_{CSIRS} − | | ^{Note 3,5} | N_{SCC}_{_{—}}_{CSIRS} − | N_{SCC}_{_{—}}_{CSIRS} − |
| PCell) | | 1 − | | | 1 − | 1 − |
| ^{Note 1} | | N_{SCC}_{_{—}}_{CSIRS} | | | N_{SCC}_{_{—}}_{CSIRS}_{_{—}}_{FR2}_{_{—}}_{NCM}) | N_{SCC}_{_{—}}_{CSIRS}_{_{—}}_{FR2}_{_{—}}_{NCM}) |
| | | _{FR2}_{_{—}}_{NCM}) | | | | |

Note 1:
Only one FR1 operating band and one FR2 operating band are included for FR1 + FR2 inter-band CA.
Note 2:
Selection of FR2 SCC where neighbour cell measurement is required follows relevant protocols.
Note 3:
CSSF_{outside}_{_{—}}_{gap, i} = 1 if only one cell is configured and no inter-frequency MO outside gap and
Note 4:
Y is the quantity of configured inter-frequency MOs that do not require an MG measured by a CA-capable UE outside the MG; otherwise, Y is 0.
Note 5:
Only two NR FR2 operating bands are included for FR2 inter-band CA.
Note 6:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 7:
N_{SCC}_{_{—}}_{CSIRS} = quantity of cells with either both SSB and CSI-RS based L3 measurement configured or only CSI-RS based L3 measurement configured
Note 8:
N_{SCC}_{_{—}}_{CSIRS}_{_{—}}_{FR2}_{_{—}}_{NCM} = 1 if FR2 SCC, where neighbor cell measurement is required, is with either both SSB and CSI-RS configured or only CSI-RS measurement configured; otherwise, N_{SCC}_{_{—}}_{CSIRS}_{_{—}}_{FR2}_{_{—}}_{NCM} = 0.
Note 9:
N_{SCC}_{_{—}}_{SSB} = quantity of configured SCell(s) with only SSB based L3 measurement configured

2. In SA scenarios, CSSF_{within gap, i} calculation of within gap

The CSSF for measurement conducted within gap is related to the quantity of MOs.

Further, according to the quantity of intra-frequency measurement objects M_{intra, i, j} in each MG (denoted as j), the quantity of inter-frequency measurement objects M_{tot, i} in each MG, the quantity of all measurement objects M_{tot, i} in each MG, and the quantity of NR PRS measurements in each MG, the CSSF of the measurement object i is determined, that is, CSSF_{within_gap, i}. M_{tot, i}, j=M_{intra, i, j}+M_{tot, i}.

Further, the sharing ratio of the intra-frequency MOs and inter-frequency MOs may be allocated according to the SharingScheme indicated by the network.

Specifically, for each MG j used in the long-period measurement, M_{intra, i, j}=M_{tot, i}=M_{tot, i}, j=0.

CSSF_{within_gap, i} is:

(1) If the parameter measGapSharingScheme indicates even sharing of MG, then: CSSF_{within_gap,i}=max(ceil(Rᵢ×M_{tot,i})), where, j=0 . . . (160/MGRP)−1.

(2) If the parameter measGapSharingScheme indicates non-equal sharing of MG, and further indicates the intra-frequency ratio Kᵢₙₜᵣₐ and the inter-frequency ratio Kᵢₙₜₑᵣ, then:
if the measurement object i is an intra-frequency measurement object, CSSF_{within_gap, i} is the maximum value among the following values:
ceil(Rᵢ×Kᵢₙₜᵣₐ×M_{intra,i,j}), where, M_{inter,i,j}≠0, j=0,1 . . . , ((160/MGRP)−1);
ceil(Rᵢ×M_{intra,i,j}), where, M_{inter,i,j}=0, j=0 . . . (160/MGRP)−1.

If the measurement object i is an inter-frequency measurement object or inter-RAT or NR PRS of any frequency layer, then CSSF_{within_gap, i} is the maximum of the following values:
ceil(Rᵢ×Kᵢₙₜₑᵣ×M_{intra,i,j}) in gaps where M_{intra, i, j}≠0, where j=0 . . . (160/MGRP)−1
ceil(Rᵢ×M_{intra,i,j}) in gaps where M_{intra, i, j}=0, where j=0 . . . (160/MGRP)−1.

Currently, only one set of SMTC and MG is usually configured at each frequency point in the terrestrial cellular network. Even if some frequency points allow two sets of SMTCs to be configured, the two sets of SMTCs only have different periods, but the time-domain offset is the same. If two SMTCs are configured, when considering the RRM indicator, only one SMTC period is referenced by default to determine the measurement period. The NTN network allows multiple SMTCs and multiple MGs to be configured on each frequency point. The association relationship between SMTC and MG, a measurement cell, a satellite, and an SSB is also under discussion. One possible configuration is that multiple cells/satellites on each frequency point/MO are associated with different SMTC configurations.

As explained previously, for MOs that do not require MG (that is, can be measured outside MG), whether the UE finally uses an MG measurement to calculate CSSF depends on the time-domain overlapping relationship between SMTC and MG. Thus, when multiple SMTCs and MGs are configured, how to determine whether an MG is required for measurements and how to determine the measurement period under multiple SMTC/MG configurations are issues that need to be solved, especially when the UE capability is less than the configured quantity of SMTC/MGs. More specifically, in the NTN, multiple SMTCs and MGs are configured, and the association relationship between the frequency point/reference signal and the MG is configured through RRC signaling. However, from RRC signaling, it may not be possible to guarantee that each frequency point will be equipped with an associated MG. In this case, it is necessary to consider how to determine whether this frequency point uses an MG-based method to calculate CSSF and how to select an MG.

The solutions provided by the embodiments of the present application are used to solve at least one of the above problems.

In order to facilitate a better understanding of the characteristics and technical contents of the embodiments of the present invention, the implementations of the embodiments of the present invention will be described in detail in the following with reference to the accompanying drawings. The attached drawings are for reference only and are not intended to limit the embodiments of the present invention.

FIG. 2 is a schematic flowchart of a method for determining a measurement period according to an embodiment of the present application. Optionally, the method may be applied to the system shown in FIG. 1, but is not limited thereto. The method includes at least part of the following contents:

S110: determining, by a terminal device, a measurement period of a first frequency point and/or a first MO based on a first positional relationship.
where the first positional relationship includes a positional relationship between at least some MGs of a plurality of configured MGs and measurement timing windows of the first frequency point and/or the first MO, and/or a positional relationship between third MGs of the plurality of MGs that are used to measure the first frequency point and/or the first MO and remaining MGs of the plurality of MGs except the third MGs.

In the embodiments of the present application, the first frequency point and/or the first MO is a to-be-measured target. Herein, the first MO may be a reference signal used for RRM measurement, which includes SSB, CSI-RS, or the like. One or more MOs may be configured on the first frequency point. In some scenarios, the terminal device may use the embodiments of the present application to determine the measurement period of the first MO. In some other scenarios, the terminal device may use the embodiments of the present application to determine the measurement period of the first frequency point, where the measurement period is applicable to each MO on the first frequency point.

Exemplarily, the measurement timing windows in the embodiments of the present application may include timing windows configured by a network, or may include timing windows determined according to a period, an offset and the like of an MO itself. For example, measurement timing windows of an SSB may be configured SMTC windows, and measurement timing windows of a CSI-RS may be configured CSI-RS measurement timing configuration (CMTC) windows. For another example, in a case where the network does not configure CMTC, the measurement timing windows of the CSI-RS may be determined according to a period of the CSI-RS.

Exemplarily, in the embodiments of the present application, the at least some MGs of the plurality of MGs may include some or all of the plurality of MGs, that is, the at least some MGs may be one or more MGs.

Exemplarily, in the embodiments of the present application, the third MGs used to measure the first frequency point and/or the first MO may be MGs determined by the terminal device from the plurality of MGs, for example, MGs determined by the terminal device according to a preset rule, priorities of respective MGs, or an association relationship between MGs and a frequency point or an MO configured by the network.

Exemplarily, the positional relationship in the embodiments of the present application may include whether timing windows (or time-domain distribution patterns, such as measurement timing windows of a frequency point or an MO, or time domain distribution patterns of an MG) overlap with, conflict with, include, or is included in one another.

It can be seen that in the method provided by the embodiments of the present application, in a case where multiple MGs are supported, the terminal device considers the positional relationship between the measurement timing windows of the frequency point and/or the MO and at least some MGs to determine the measurement period of the frequency point and/or the MO. Therefore, the quantity of sampling within a measurement period may be ensured, which is beneficial to improving the accuracy of measurement.

In practical applications, different information may be adopted to determine the measurement period of the first frequency point and/or the first MO based on whether the first frequency point and/or the first MO requires an MG.

Optionally, as shown in FIG. 3A, the above-described step S110: the determining, by the terminal device, the measurement period of the first frequency point and/or the first MO based on the first positional relationship includes:

S210: determining, by the terminal device, the measurement period of the first frequency point and/or the first MO based on the positional relationship between the at least some MGs of the plurality of MGs and the measurement timing windows of the first frequency point and/or the first MO in response that MGs are not required to be used in a measurement of the first frequency point and/or the first MO.

Exemplarily, if MGs are not required to be used in a measurement of the first frequency point and/or the first MO, the terminal device may consider measuring outside MG, and the terminal device may determine whether the measurement is actually to be performed outside MG based on the positional relationship between the measurement timing windows of the first frequency point and/or the first MO and one or more MGs, so as to determine whether the measurement period is to be determined according to relevant parameters for measurement conducted outside MG or relevant parameters for measurement conducted within MG.

Further optionally, in a case where it is unnecessary to use an MG, whether the measurement period is to be determined based on a positional relationship between the measurement timing windows and each MG, or a positional relationship between the measurement timing windows of the first frequency point and/or the first MO and the associated MGs can further be determined based on whether the network has configured MGs associated with the first frequency point and/or the first MO.

For example, in a case where the first frequency point and/or the first MO is not configured with associated MGs, the at least some MGs include each MG of the plurality of MGs.

For another example, in a case where the first frequency point and/or the first MO is configured with associated MGs, the at least some MGs include fourth MGs configured by the network device and associated with the first frequency point and/or the first MO.

Optionally, as shown in FIG. 3B, the above-described step S110: the determining, by the terminal device, the measurement period of the first frequency point and/or the first MO based on the first positional relationship includes:

S220: determining, by the terminal device, the measurement period of the first frequency point and/or the first MO based on the positional relationship between the third MGs and remaining MGs of the plurality of MGs except the third MGs in response that MGs are required to be used in a measurement of the first frequency point and/or the first MO.

Exemplarily, if MGs are required to be used in the measurement of the first frequency point and/or the first MO, the terminal device first determines the third MGs used to measure the first frequency point and/or the first MO, then determines relevant parameters for measurement conducted within the third MGs based on the positional relationship between the third MGs and other MGs, and determines the measurement period of the first frequency point and/or the first MO based on the relevant parameters for measurement conducted within the third MGs.

Optionally, in a case where MGs are required to be used in the measurement of the first frequency point and/or the first MO, other ways may be adopted to determine the measurement period. Specifically, the method for determining a measurement period may further include:
determining, by the terminal device, measurement periods corresponding to respective MGs of the plurality of MGs based on relevant parameters for measurement conducted within the respective MGs in response that MGs are required to be used in a measurement of the first frequency point and/or the first MO;
determining, by the terminal device, the measurement period of the first frequency point and/or the first MO based on a maximum value or a minimum value of the measurement periods corresponding to the respective MGs of the plurality of MGs.

Optionally, the embodiments of the present application are further related to the method for calculating a CSSF corresponding to a configured MG. Specifically, for each MG of the plurality of MGs, the CSSF for measurement conducted within the MG is related to at least one of the following (more specifically, the CSSF measured within the MG is determined with reference to a quantity of the following frequency points and/or MOs):
a frequency point and/or an MO associated with the MG; or
a frequency point and/or an MO whose measurement periods are determined based on relevant parameters for measurement conducted within the MG.

Some specific embodiments will be provided in the following to illustrate and explain the methods for determining a measurement period in the various cases mentioned above. It can be understood that the following different embodiments are descriptions of different situations. Therefore, the following embodiments can be combined with each other. For example, in a case, the implementation described in Embodiment 1 may be adopted, and in another case, the implementations described in Embodiment 2, 3 or 4 may be adopted. These combinations all fall within the protection scope of the present application.

### Embodiment 1

This embodiment provides an exemplary implementation that the terminal device determines the measurement period of the first frequency point and/or the first MO in a case where the first frequency point and/or the first MO does not require MGs, and the network does not configure MGs associated with the first frequency point and/or the first MO.

Specifically, specific examples are provided according to the following cases 1-7, respectively. It should be noted that in some cases, this embodiment assumes that two MG configurations are supported (for example, a UE that supports per-FR only configures two types of MGs in one FR, or a UE that does not support per-FR configures two per-UE MGs), and describe an example with two types of MGs. On this basis, this embodiment may be extended to scenarios supporting at least three MG configurations.

Case 1: none of the measurement timing windows of the first frequency point and/or the first MO are overlapped by respective MGs of the plurality of MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the plurality of MGs in a case where none of the measurement timing windows of the first frequency point and/or the first MO are overlapped by respective MGs of the plurality of MGs.

It should be noted that the relevant parameters in the embodiments of the present application include a CSSF and/or a first scaling factor Kp.

Exemplarily, the relevant parameters for measurement conducted outside the plurality of MGs include a CSSF for measurement conducted outside the plurality of MGs, that is, a CSSF calculated by using the outside gap method, and first scaling factor Kp for measurement conducted outside the plurality of MGs. Since none of the measurement timing windows are overlapped by each MG, Kp=1.

For example, in a case where a reference signal or an SMTC is not overlapped by any MG, the CSSF is calculated by using the outside gap method, and Kp=1.

Case 2: all of the measurement timing windows of the first frequency point and/or the first MO are overlapped by first MGs of the plurality of MGs and none of the measurement timing windows of the first frequency point and/or the first MO are overlapped by second MGs of the plurality of MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within first MGs of the plurality of MGs in a case where all of the measurement timing windows of the first frequency point and/or the first MO are overlapped by the first MGs and none of the measurement timing windows of the first frequency point and/or the first MO are overlapped by second MGs of the plurality of MGs.

For example, in a case where all the reference signals or SMTCs are overlapped by MG1 and none of the reference signals or SMTCs are overlapped by MG2, the CSSF is calculated by using the within gap method, where the CSSF is marked as CSSF_MG1 below. In addition, Kp=1. Frequency points or MOs associated with MG1 need to be considered upon calculating CSSF_MG1.

Case 3: part of the measurement timing windows of the first frequency point and/or the first MO are overlapped by first MGs of the plurality of MGs and none of the measurement timing windows of the first frequency point and/or the first MO are overlapped by second MGs of the plurality of MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within first MGs of the plurality of MGs or relevant parameters for measurement conducted outside the first MGs in a case where part of the measurement timing windows of the first frequency point and/or the first MO are overlapped by the first MGs and none of the measurement timing windows of the first frequency point and/or the first MO are overlapped by second MGs of the plurality of MGs.

For example, in a case where part of the reference signals or the SMTCs are overlapped by MG1 and are not overlapped by MG2, the within gap method may be adopted to determine CSSF_MG1, or the outside gap method may be adopted to calculate CSSF_outside MG1. The measurement period is then determined according to CSSF_MG1 or CSSF_outside MG1.

Optionally, a first scaling factor Kp in the relevant parameters for measurement conducted within the first MGs is determined based on a period of the first MG. Exemplarily, the first scaling factor Kp for measurement conducted within the first MGs may be determined based on a ratio of a period of the first MGs to a period of the measurement timing windows.

Optionally, a first scaling factor in the relevant parameters for measurement conducted outside the first MGs is determined based on a period of the first MG. Exemplarily, the first scaling factor Kp for measurement conducted outside the first MGs may be determined based on a ratio between the period of the first MGs and the period of the measurement timing windows. Specifically, Kp is obtained by except a portion of the measurement timing windows corresponding to the ratio.

For example, if a measurement period is determined according to the relevant parameters for measurement conducted within the first MGs, the within gap method is then adopted to calculate CSSF_MG1, and Kp1=MGRP1/SMTC period. Frequency points or MOs associated with MG1 need to be considered upon calculating CSSF_MG1.

Taking a case without DRX configuration as an example, the measurement period may be max (Tthr, ceil (Nsample×Kp1)×SMTC period)×CSSF_MG1. Since Kp1×SMTC period=MGRP1, the measurement period may be approximately equivalent to be measured based on the period MGRP1 of MG1, i.e., max (Tthr, Nsample×MGRP1)×CSSF_MG1.

For another example, if a measurement period is determined based on the relevant parameters for measurement conducted outside the first MGs, the outside gap method is then adopted to calculate CSSF_outside MG1, and Kp1=1/(1−(SMTC period/MGRP1)), a measurement period is max (Tthr, ceil (Nsample×Kp1)×SMTC period)×CSSF_outside MG1.

Herein, Tthr is a preset threshold, such as 600 ms; Nsample is a quantity of sampling points; SMTC period indicates a period of the first frequency point and/or the first MO.

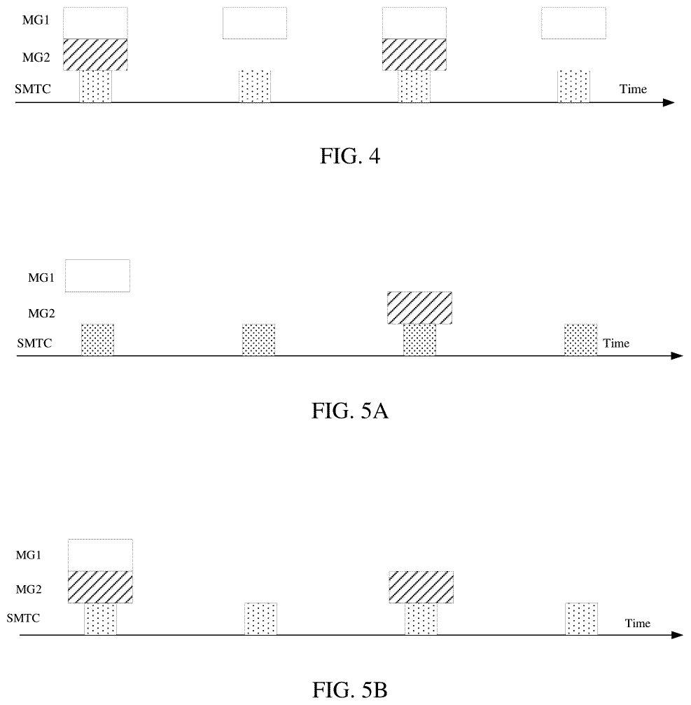

Case 4: all of the measurement timing windows of the first frequency point and/or the first MO are overlapped by first MGs of the plurality of MGs and part of the measurement timing windows of the first frequency point and/or the first MO are overlapped by second MGs of the plurality of MGs. For example, as shown in FIG. 4, all the reference signals or the SMTCs are overlapped by MG1 and part of the reference signals or the SMTCs are overlapped by another MG2, which means that MG1 and MG2 partially overlap, such as partial-full overlapping (partial-full overlapping) and partial-partial overlapping (partial-partial overlapping).

Specifically, Case 4 includes the following subdivided cases.

Case 4-1: all of the measurement timing windows of the first frequency point and/or the first MO overlapped by the first MGs and part of the measurement timing windows of the first frequency point and/or the first MO overlapped by the second MGs of the plurality of MGs, and priorities of the plurality of MGs are uncertain, or the plurality of MGs have the same priority. That is, from the perspective of a UE, there is no difference between the plurality of MGs in terms of priority.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the first MGs of the plurality of MGs and/or relevant parameters for measurement conducted outside second MGs in response that priorities of the plurality of MGs are uncertain or the same, in a case where all of the measurement timing windows of the first frequency point and/or the first MO are overlapped by the first MGs and part of the measurement timing windows of the first frequency point and/or the first MO are overlapped by the second MGs of the plurality of MGs.

Herein, a first scaling factor Kp in the relevant parameters for measurement conducted within the first MGs is a preset value, such as 1. A first scaling factor Kp in the relevant parameters for measurement conducted outside the second MGs is determined based on the period of the second MG.

Specifically, the following examples may be used for implementation.

Example 1: the measurement period of the first frequency point and/or the first MO is determined based on the relevant parameters for measurement conducted within the first MGs.

For example, the calculation is based on measurement conducted within the first MGs (MG1), CSSF_MG1 is calculated by using the within gap method, and a first scaling factor Kp1 for measurement conducted within the first MGs is 1.

If there is no DRX configuration, a measurement period may be modified to max (Tthr, ceil (Nsample×Kp1)×SMTC period)×CSSF_MG1.

If DRX-cycle≤320 ms, the measurement period is max (Tthr, ceil(M2×Nₛₐₘₚₗₑ×Kp)×max (SMTC period, DRX cycle))×CSSF_MG1.

If DRX cycle>320 ms, the measurement period is ceil (Nsample×Kp)×DRX cycle×CSSF_MG1.

Example 2: the measurement period of the first frequency point and/or the first MO is determined based on the relevant parameters for measurement conducted outside the second MG.

For example, CSSF is calculated based on the method for measurement conducted outside the second MGs (i.e., outside gap MG2), and a first scaling factor Kp2 for measurement conducted outside the second MGs is 1/(1−(SMTC period/MGRP2)).

Taking a case without DRX configuration as an example, the measurement time may be max (Tthr, ceil (Nsample×Kp2)×SMTC period)×CSSF_outside MG2. Other cases are similar and will not be repeated herein.

Example 3: the measurement period of the first frequency point and/or the first MO is determined based on the relevant parameters for measurement conducted within the first MGs and/or the relevant parameters for measurement conducted outside the second MG.

Specifically, the determining, by the terminal device, the measurement period of the first frequency point and/or the first MO based on the relevant parameters for measurement conducted within the first MGs and/or the relevant parameters for measurement conducted outside the second MGs includes:
determining, by the terminal device, the measurement period of the first frequency point and/or the first MO based on a maximum value or a minimum value of a first measurement period and a second measurement period; where the first measurement period is determined based on the relevant parameters for measurement conducted within the first MGs, and the second measurement period is determined based on the relevant parameters for measurement conducted outside the second MG.

In practical applications, two respective measurement periods can be determined based on the methods of Example 1 and Example 2, and then the maximum value or the minimum value can be taken as the measurement period from the determined measurement periods.

For example, if there is no DRX configuration, the measurement period is max/min (max (Tthr, ceil (Nsample×Kp1)×SMTC period)×CSSF_MG1, max (Tthr, ceil (Nsample×Kp2)×SMTC period)×CSSF_outside MG2), where the values of Kp/CSSF, or the other parameters are the same as the values of these parameters in Example 1 and Example 2.

Case 4-2: all of the measurement timing windows of the first frequency point and/or the first MO are overlapped by first MGs of the plurality of MGs and part of the measurement timing windows of the first frequency point and/or the first MO are overlapped by the second MGs of the plurality of MGs, and priorities of respective MGs are configured.

The following examples may be adopted for implementation.

Example 1: this example is applicable to a scenario where a priority of first MGs is higher than a priority of the second MG.

Specifically, the determining, by the terminal device, the measurement period of the first frequency point and/or the first MO based on the positional relationship between the at least some MGs of the plurality of MGs and the measurement timing windows of the first frequency point and/or the first MO includes:

determining, by the terminal device, the measurement period of the first frequency point and/or the first MO based on relevant parameters for measurement conducted within first MGs of the plurality of MGs in response that a priority of the first MGs is higher than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs.

For example, if MG1 has a higher priority, it means that measurement gaps that are activated at time-domain locations of SMTC are actually all MG1, and there is no MG2 (that is, there is no activated MG2 overlapping SMTC). As the same with Example 1 of Case 4-1, it is based on the measurement conducted within MG1, and CSSF_MG1 is adopted and Kp1=1.

For example, if there is no DRX configuration, the measurement periods may be max (Tthr, ceil (Nsample×Kp1)×SMTC period)×CSSF_MG1.

Example 2: this example is applicable to a scenario where a priority of the first MGs is lower than a priority of the second MGs. For example, if MG2 has a higher priority, according to actually activated MGs, part of SMTCs are overlapped by the activated MG1, and the other SMTCs are overlapped by the activated MG2.

The following examples may be used for implementation.

### Example 2-1

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a third measurement period and a fourth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the third measurement period is determined based on the relevant parameters for measurement conducted within the first MGs, and the fourth measurement period is determined based on the relevant parameters for measurement conducted within the second MG.

For example, CSSF_MG1 and CSSF_MG2 are calculated based on measurements in MG1 and MG2, respectively, and after the measurement periods are determined, the maximum value (or the minimum value) of the measurement periods is taken as the measurement period. Taking a case without DRX configuration as an example, the measurement period may be modified as max (max (Tthr, ceil (Nsample×Kp1)×SMTC period)×CSSF_MG1, max(Tthr, ceil (Nsample×Kp2)×SMTC period)×CSSF_MG2).

Optionally, in this example, a first scaling factor Kp1 in the relevant parameters for measurement conducted within the first MGs is a preset value or is determined based on a period of the second MG. Exemplarily, Kp1=1, or Kp1=1/(1−(SMTC period/MGRP2)).

Optionally, a first scaling factor Kp2 in the relevant parameters for measurement conducted within the second MGs is a preset value or is determined based on a period of the second MG. Exemplarily, Kp2=1, or Kp2=MGRP2/SMTC.

In a possible case, Kp1=1, Kp2=1 (indicating that this frequency point can be measured within the two types of MGs).

In another possible case, Kp1=1 (because all SMTCs are within MG1), Kp2=MGRP2/SMTC (only the portion of SMTC falling within MG2 is considered, and the proportion of SMTC outside MG2 is deducted).

In another possible case, Kp1=1/(1−(SMTC period/MGRP2)) (only the portion of MG1 falling before MG2 is considered), Kp2=MGRP2/SMTC (only the portion of SMTC falling within MG2 is considered).

Optionally, when calculating CSSFs of other frequency points/MOs associated with MG1 or MG2, the frequency point/MO needs to be taken into account.

### Example 2-2

In this example, it is assumed that there is only one type of MGs and one type of measurement timing windows such as SMTC. Based on the case that there is only one type of MGs and one type of measurement timing windows, an overlapping relationship is determined. Measurement periods are calculated according to the aforementioned related technologies, and the maximum value (or the minimum value) of the measurement periods is then taken as the measurement period. Specifically, according to the aforementioned related technologies, since all of the measurement timing windows are overlapped by first MGs, a measurement period is determined based on relevant parameters for measurement conducted within the first MGs. Since part of the measurement timing windows are overlapped by second MGs, a measurement period is determined based on relevant parameters for measurement conducted outside the second MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a fifth measurement period and a sixth measurement period in response that a priority of the first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the fifth measurement period is determined based on relevant parameters for measurement conducted within the first MGs, and the sixth measurement period is determined based on relevant parameters for measurement conducted outside the second MG. For example, it is implemented through the following steps.

Step-1: first assuming that only MG1 is configured, since MG1 and SMTC completely coincide, the calculation is based on CSSF_MG1 and Kp=1. Taking a case without DRX configuration as an example, the measurement period is max(Tthr, ceil (Nsample×Kp1)×SMTC period)×CSSF_MG1.

Optionally, upon calculating CSSF of other frequency points/MOs associated with MG1, this frequency point/MO needs to be taken into account.

Step-2: then assuming that only MG2 is configured, since SMTC and MG2 partially coincide, the calculation is based on CSSF_outside MG2 and Kp2=1/(1−(SMTC period/MGRP2)). Taking a case without DRX configuration as an example, the measurement period is max(Tthr, ceil (Nsample×Kp2)×SMTC period)×CSSF_outside MG2.

Step-3: finally the maximum value (or the minimum value) of the two measurement periods is taken as the measurement period.

It should be noted that the precedence relationship between the above Step-1 and Step-2 may be interchanged. For example, Step-2 may be executed first, and then Step-1 is executed; or, the above-mentioned Step-1 and Step-2 may be executed in parallel.

Example 2-3: in this example, the actually activated MGs may be determined according to priorities of respective MGs. Based on the case that there is only one type of MGs and one type of measurement timing windows, an overlapping relationship between the actually activated MGs and the measurement timing windows is determined, and the measurement periods are calculated according to the aforementioned related technologies, and the maximum value (or the minimum value) of the measurement periods is then taken as the measurement period. Specifically, since part of the measurement timing windows are overlapped by actually activated portions of the first MGs, a measurement period is determined based on relevant parameters for measurement conducted outside the first MGs. Since the second MGs are actually fully activated and part of the measurement timing windows are overlapped by the second MGs, a measurement period is determined based on relevant parameters for measurement conducted outside the first MGs.

In practical applications, the following examples may be used to implement the present application. The difference is that, in Example A, the proportion distribution between MGs is not taken into account upon calculating a measurement period; in Example B, a proportion factor between MGs is taken into account upon calculating a measurement period.

Example A: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a seventh measurement period and an eighth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the seventh measurement period is determined based on relevant parameters for measurement conducted outside the first MGs, and the eighth measurement period is determined based on relevant parameters for measurement conducted outside the second MG.

For example, taking a case without DRX configuration as an example, the seventh measurement period is max(Tthr, ceil (Nsample×Kp1)×SMTC period)×CSSF_outside MG1, and the eighth measurement period is max(Tthr, ceil (Nsample×Kp2)×SMTC period)×CSSF_outside MG2. The maximum value (or the minimum value) of the two times is taken as the measurement period.

Herein, Kp1 represents a portion of SMTC outside MG1, Kp1=MGRP2/SMTC, Kp2=1/(1−(SMTC period/MGRP2)).

Example B: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on a maximum value or a minimum value of a ninth measurement period and a tenth measurement period or a sum of the ninth measurement period and the tenth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the ninth measurement period is determined based on relevant parameters for measurement conducted outside the first MGs and the first ratio corresponding to the first MGs, and the tenth measurement period is determined based on relevant parameters for measurement conducted outside the second MGs and a second ratio corresponding to the second MG.

For example, if the first ratio is Y1, the second ratio is Y2, taking a case without DRX configuration as an example, the ninth measurement period is max(Tthr, ceil (Nsample×Kp1)×SMTC period)×CSSF_outside MG1×Y1, and the tenth measurement period is max(Tthr, ceil (Nsample×Kp2)×SMTC period)×CSSF_outside MG2× Y2. The maximum value (or the minimum value) of the two durations or the sum of the two durations is taken as the measurement period.

The values of Kp1 and Kp2 are the same as the values of Kp1 and Kp2 in Example A, and CSSFs are all calculated by using the outside MG method.

Optionally, the first ratio and the second ratio are determined based on the relevant parameters for measurement conducted outside the first MGs and the relevant parameters for measurement conducted outside the second MG. For example, Y1 and Y2 may be calculated according to Kp1 and Kp2, e.g., Y1=Kp1/(Kp1+Kp2), Y2=Kp2/(Kp1+Kp2). For another example, Y1 and Y2 may be calculated according to Kp1, Kp2 and CSSF, e.g., Y1=Kp1/(CSSF_outside MG1+CSSF_outside MG2), Y2=Kp2/(CSSF_outside MG1+CSSF_outside MG2).

Optionally, the first ratio and the second ratio are determined based on a first sharing factor configured by a network device. For example, the network configures the first sharing factor (e.g., a gap sharing factor) including a first ratio and a second ratio. Alternatively, the first ratio and the second ratio may be determined based on the gap sharing factor, for example, the first ratio is (1-gap sharing factor), and the second ratio is the gap sharing factor.

Case 5: part of the measurement timing windows of the first frequency point and/or the first MO are overlapped by respective MGs of the plurality of MGs, and the measurement timing windows include a part of measurement timing windows that are not overlapped by any one of the MGs. For example, as shown in FIG. 5A and FIG. 5B, part of the measurement timing windows SMTCs are overlapped by MG1, part of the measurement timing windows SMTCs are overlapped by MG2, and part of the SMTCs are outside the two types of MGs. If the periods of the two types of MGs are different, as shown in FIG. 5A, SMTC period <min (MGRP1, MGRP2); if the two periods are the same, as shown in FIG. 5B, 2×SMTC period <MGRP1, where MGRP1=MGRP2.

The following examples may be used for implementation.

Example 1: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the plurality of MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

Herein, the relevant parameters for measurement conducted outside the plurality of MGs include a CSSF and a first scaling factor Kp. The CSSF is calculated according to the outside gap method. The measurement period may be max(Tthr, ceil (Nsample×Kp)×SMTC period)×CSSF_outside MG.

Optionally, the first scaling factor Kp in the relevant parameters for measurement conducted outside the plurality of MGs is determined based on a positional relationship between the plurality of MGs.

Exemplarily, in a case where the plurality of MGs does not overlap with each other, the first scaling factor Kp is determined based on periods of the respective MGs.

For example, if MG1 does not overlap with MG2 at all, such as full non-overlapping shown in FIG. 5A, Kp=1/(1−(SMTC period/MGRP1)−(SMTC period/MGRP2)).

Exemplarily, in a case where the plurality of MGs overlaps, the first scaling factor Kp is determined based on the minimum value in the periods of the respective MGs.

For example, if MG1 and MG2 completely overlap, or some occasions of the two types of MGs completely or partially overlap, or all occasions of the two types of MGs partially overlap, Kp=1/(1−(SMTC period/min (MGRP1, MGRP2))).

The above-described methods may be used in a case where the terminal device is not certain about the priorities of the plurality of MGs or the priorities of the plurality of MGs are different or same. Specifically, determining, by the terminal device, the measurement period of the first frequency point and/or the first MO based on the relevant parameters for measurement conducted outside the plurality of MGs includes:

determining, by the terminal device, the measurement period of the first frequency point and/or the first MO based on the relevant parameters for measurement conducted outside the plurality of MGs in a case where priorities of the plurality of MGs are uncertain or the priorities of the plurality of MGs are different or the same.

Example 2: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

Herein the third MGs are determined based on a preset rule or priorities of the respective MGs of the plurality of MGs.

For example, one of the MGs is selected according to a certain rule or one MG is selected for measurement based on a priority, for example, MG1 with a higher priority is selected. If MG1 is selected, the measurement period is max(Tthr, ceil (Nsample×Kp1)×SMTC period)×CSSF_MG1, Kp1=MGRP1/SMTC period. Since Kp1×SMTC period=MGRP1, the measurement period may be approximately equivalent to be measured based on the period MGRP1 of MG1. i.e., max(Tthr, Nsample×MGRP1)×CSSF_MG1. Optionally, upon calculating the CSSF of other frequency points/MOs associated with the selected MG, this frequency point/MO needs to be taken into account. Unselected MGs do not take this frequency point/MO into consideration.

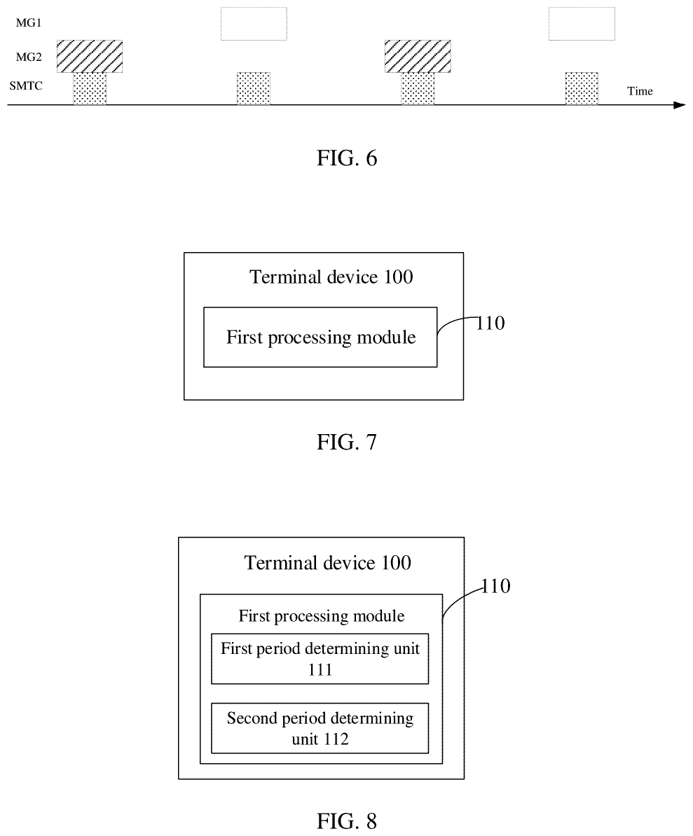

Case 6: part of the measurement timing windows of the first frequency point and/or the first MO are overlapped by respective MGs of the plurality of MGs, and the measurement timing windows do not include a part of measurement timing windows that are not overlapped by any one of the plurality of MGs. For example, as shown in FIG. 6, part of SMTCs are overlapped by MG1, and also overlapped by MG2, but there is no SMTC outside the two types of MGs (the two types of MGs do not overlap with each other, and since there is no conflict between MGs, MGRP1=MGRP2=2*SMTC period.

Implementations of the following two examples are provided.

Example 1: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within respective MGs of the plurality of MGs in a case where part of the measurement timing windows of the first frequency point and/or the first MO are overlapped by the respective MGs of the plurality of MGs, and the measurement timing windows do not include a part of measurement timing windows that are not overlapped by any one of the plurality of MGs.

Optionally, the determining, by the terminal device, the measurement period of the first frequency point and/or the first MO based on the relevant parameters for measurement conducted within the respective MGs of the plurality of MGs includes:

determining, by the terminal device, the measurement period of the first frequency point and/or the first MO based on a maximum value or a minimum value of CSSFs for measurement conducted within the respective MGs of the plurality of MGs.

For example, if CSSFs are calculated based on measurements in MG1 and MG2 respectively, and the maximum value (or the minimum value) of CSSFs is taken to calculate the measurement period, then the measurement period is max(Tthr, ceil (Nsample×Kp)×SMTC period)×max(CSSF_MG1, CSSF_MG2), where Kp=1.

Optionally, the determining, by the terminal device, the measurement period of the first frequency point and/or the first MO based on the relevant parameters for measurement conducted within the respective MGs of the plurality of MGs includes:
determining, by the terminal device, measurement periods corresponding to respective MGs of the plurality of MGs based on relevant parameters for measurement conducted within the respective MGs;
determining, by the terminal device, the measurement period of the first frequency point and/or the first MO based on a maximum value or a minimum value of the measurement periods corresponding to the respective MGs of the plurality of MGs.

For example, calculating durations based on MG1 or MG2 measurements, and then taking the maximum value (or the minimum value) includes the following steps:
Step-1: based on the measurement conducted within MG1, determining the corresponding measurement period max(Tthr, ceil (Nsample×Kp1)×SMTC period)× CSSF_MG1, Kp1=MGRP1/SMTC=2;
Step-2: similarly, based on the measurement within MG2, determining the corresponding measurement period max(Tthr, ceil (Nsample×Kp2)×SMTC period)×CSSF_MG2, Kp2=MGRP2/SMTC=2;
Step-3: taking the maximum value (or the minimum value) of the results of the first two steps.

It should be noted that Step-1 and Step-2 can be executed sequentially or in parallel. In a case of sequential execution, the order between Step-1 and Step-2 is not limited.

Optionally, upon calculating CSSFs of other frequency points/MOs associated with MG1 or MG2, the frequency point/MO needs to be taken into account.

Example 2: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

Optionally, the third MGs are determined based on a preset rule or priorities of the respective MGs of the plurality of MGs.

For example, one of the MGs is selected according to a certain rule or one MG is selected for measurement based on a priority, for example, MG1 with a higher priority is selected. If MG1 is selected, the measurement period is max(Tthr, ceil (Nsample×Kp1)×SMTC period)×CSSF_MG1, Kp1=MGRP1/SMTC period. Since Kp1×SMTC period=MGRP1, the measurement period may be approximately equivalent to be measured based on the period MGRP1 of MG1. i.e., max(Tthr, Nsample×MGRP1)×CSSF_MG1.

Optionally, upon calculating the CSSF of other frequency points/MOs associated with the selected MG, this frequency point/MO needs to be taken into account. Unselected MGs do not take this frequency point/MO into consideration.

Case 7: all of the measurement timing windows of the first frequency point and/or the first MO are overlapped by respective MGs of the plurality of MGs.

Implementations of the following two examples are provided.

Example 1: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on CSSFs corresponding to measurements conducted within respective MGs of the plurality of MGs in a case where all of the measurement timing windows of the first frequency point and/or the first MO are overlapped by the respective MGs of the plurality of MGs.

Optionally, the determining, by the terminal device, the measurement period of the first frequency point and/or the first MO based on the CSSFs corresponding to measurements conducted within the respective MGs of the plurality of MGs may include:
determining, by the terminal device, the measurement period of the first frequency point and/or the first MO based on a maximum value or a minimum value of CSSFs corresponding to measurements conducted within the respective MGs of the plurality of MGs.

For example, when no priority is configured, CSSFs can be calculated based on measurements conducted within MG1 and MG2, and the maximum value (or the minimum value) is taken to calculate the measurement period. For example, the measurement period is max(Tthr, ceil(Nsample×Kp)×SMTC period)×max(CSSF_MG1, CSSF_MG2), where Kp=1.

Optionally, the determining, by the terminal device, the measurement period of the first frequency point and/or the first MO based on the CSSFs corresponding to measurements conducted within the respective MGs of the plurality of MGs includes:
determining, by the terminal device, second scaling factors corresponding to respective MGs of the plurality of MGs, based on the CSSFs corresponding to measurements conducted within respective MGs of the plurality of MGs and second sharing factors corresponding to respective MGs of the plurality of MGs;
determining, by the terminal device, the measurement period of second the first frequency point and/or the first MO based on a maximum value or a minimum value of the scaling factors corresponding to the respective MGs of the plurality of MGs.

For example, a second sharing factor between MGs may be additionally considered. For example, the sharing factor of MG1 is sharing factor1 and the sharing factor of MG2 is sharing factor2. Then the second scaling factor corresponding to MG1 is CSSF_MG1*sharing factor1, the second scaling factor corresponding to MG2 is CSSF_MG2*sharing factor 2, and the measurement period can be max(Tthr, ceil (Nsample×Kp)×SMTC period)×max(CSSF_MG1*sharing factor1, CSSF_MG2*sharing factor 2).

Optionally, upon calculating CSSFs of other frequency points/MOs associated with MG1 or MG2, the frequency point/MO needs to be taken into account.

Example 2: the determining, by the terminal device, the measurement period of the first frequency point and/or the first MO based on the positional relationship between the at least some MGs of the plurality of MGs and the measurement timing windows of the first frequency point and/or the first MO includes:

determining, by the terminal device, third MGs used to measure the first frequency point and/or the first MO, of the plurality of MGs and determining, by the terminal device, the measurement period of the first frequency point and/or the first MO based on relevant parameters for measurement conducted within the third MGs in a case where all of the measurement timing windows of the first frequency point and/or the first MO are overlapped by the respective MGs of the plurality of MGs.

Optionally, the third MGs are determined based on a preset rule or priorities of the respective MGs of the plurality of MGs.

For example, one of the MGs is selected according to a certain rule or one MG is selected for measurement based on a priority, for example, MG1 with a higher priority is selected. If MG1 is selected, the measurement period is max(Tthr, ceil (Nsample×Kp1)×SMTC period)×CSSF_MG1, Kp1=MGRP1/SMTC period.

Optionally, upon calculating the CSSF of other frequency points/MOs associated with the selected MG, this frequency point/MO needs to be taken into account. Unselected MGs do not take this frequency point/MO into consideration.

### Embodiment 2

This embodiment provides an exemplary implementation that the terminal device determines the measurement period of the first frequency point and/or the first MO in a case where the first frequency point and/or the first MO does not require MGs, and the network configures MGs associated with the first frequency point and/or the first MO.

Specifically, in this embodiment, the terminal device determines the measurement period of the first frequency point and/or the first MO based on the positional relationship between the measurement timing windows of the first frequency point and/or the first MO and at least some MGs, where the at least some MGs include fourth MGs configured by a network device and associated with the first frequency point and/or the first MO.

That is, in this embodiment, the relationship between the associated MGs (taking MG1 as an example) and the measurement timing windows is mainly considered. For the first frequency point and/or the first MO, the CSSF is calculated outside MG1, or the CSSF is calculated by choosing the within MG1 method).

Optionally, if this frequency point/MO is determined to be measured by outside gap, then the frequency point/MO does not need to be considered upon calculating the CSSF of the associated MG (even if the network is configured an association relationship); if this frequency point/MO is determined to be measured by within gap, then the frequency point/MO needs to be considered upon calculating the CSSF of the associated MG.

Specifically, specific examples are provided according to the following cases 1-3, respectively.

Case 1: none of the measurement timing windows of the first frequency point and/or the first MO are overlapped by the fourth MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the fourth MGs in a case where none of the measurement timing windows of the first frequency point and/or the first MO are overlapped by the fourth MGs.

For example, none of the SMTCs are overlapped by the associated MGs, and the only choice is to use the outside gap method to calculate the CSSF. When DRX cycle is not configured, the measurement period is max(Tthr, ceil (Nsample×Kp)×SMTC period)×CSSF_outside MG1.

Optionally, the value of the first scaling factor Kp may be:
in a case where none of the measurement timing windows are overlapped by remaining MGs of the plurality of MGs except the fourth MGs, a first scaling factor Kp in the relevant parameters for measurement conducted outside the fourth MGs is a preset value. For example, if all of SMTCs are not overlapped by other MGs, Kp=1;
in a case where part of the measurement timing windows are overlapped by other MGs (such as MG2) in the plurality of MGs except the fourth MGs, the first scaling factor Kp in the relevant parameters for measurement conducted outside the fourth MGs is determined based on the periods of the other MGs. For example, if part of SMTCs are overlapped by MG2, Kp=1/(1−(SMTC period/MGRP2)).

In case 1, it is not expected that all of the measurement timing windows of the first frequency point and/or the first MO are overlapped by other MGs.

Case 2: all of the measurement timing windows of the first frequency point and/or the first MO are overlapped by the fourth MGs.

Specifically, the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the fourth MGs in a case where all of the measurement timing windows of the first frequency point and/or the first MO are overlapped by the fourth MGs.

Specifically, Case 2 is subdivided into the following cases:

Case 2-1: the fourth MGs do not overlap with other MGs in the plurality of MGs except the fourth MGs (for example, the associated MG is MG1, and MG1 does not conflict with other MGs).

In a case that the fourth MGs do not overlap with other MGs in the plurality of MGs except the fourth MGs, the first scaling factor Kp in the relevant parameters for measurement conducted within the fourth MGs is a preset value.

For example, when MG1 does not conflict with other MGs (and there is no gap cancel mechanism that will cancel certain occasions of MG1, if so, the scaling factor Kgap needs to be adopted to increase the measurement period by using the method of Case 2-2 or Case 2-3). At this time, the measurement period can be max(Tthr, ceil (Nsample×Kp)×SMTC period)×CSSF_MG1, Kp=1.

Case 2-2: the fourth MGs overlap with other MGs in the plurality of MGs except the fourth MGs (for example, the associated MG is MG1, and MG1 conflicts with other MGs), and the priority of each MG is configured.

Optionally, the determining, by the terminal device, the measurement period of the first frequency point and/or the first MO based on the relevant parameters for measurement conducted within the fourth MGs includes:

determining, by the terminal device, the measurement period of the first frequency point and/or the first MO based on the relevant parameters for measurement conducted within the fourth MGs in response that a priority of the fourth MGs is higher than priorities of the remaining MGs of the plurality of MGs except the fourth MGs, in a case where the fourth MGs overlap with the remaining MGs.

For example, if the associated MG1 is the highest priority, the measurement period can be max(Tthr, ceil (Nsample×Kp)×SMTC period)×CSSF_MG1.

Optionally, the determining, by the terminal device, the measurement period of the first frequency point and/or the first MO based on the relevant parameters for measurement conducted within the fourth MGs includes:

determining, by the terminal device, the measurement period of the first frequency point and/or the first MO based on the relevant parameters for measurement conducted within the fourth MGs and a third scaling factor in response that a priority of the fourth MGs is lower than priorities of remaining MGs of the plurality of MGs except the fourth MGs, in a case where the fourth MGs overlap with the remaining MGs, where the third scaling factor is determined based on ratios between periods of the remaining MGs and a period of the fourth MGs.

For example, if the associated MG1 has a low priority, the measurement period can be max(Tthr, ceil (Nsample×Kp)×SMTC period)×CSSF_MG1*Kgap, where the third scaling factor Kgap indicates an scaling factor brought by the part MG1 occasion discarded due to the conflict with other MGs. Kgap=MGRP2/MGRP1.

Case 2-3: the fourth MGs overlap with other MGs in the plurality of MGs except the fourth MGs (for example, the associated MG is MG1, and MG1 conflicts with other MGs), and the priority of each MG is not configured.

Specifically, the determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs and a fourth scaling factor in a case where the fourth MGs overlap with remaining MGs of the plurality of MGs except the fourth MG; where the fourth scaling factor is determined based on a sharing ratio configured by a network device.

For example, the measurement period may be max(Tthr, ceil (Nsample×Kp)×SMTC period)×CSSF_MG1*Kgap, where the fourth scaling factor Kgap may be calculated based on a gap sharing parameter configured in the network, for example, when the MG1 sharing ratio is 30%, Kgap=100/30.

Case 3: part of the measurement timing windows of the first frequency point and/or the first MO are overlapped by the fourth MGs.

Implementations of the following examples are included.

Example 1: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted outside the fourth MGs in a case where part of the measurement timing windows of the first frequency point and/or the first MO are overlapped by the fourth MGs.

For example, when part of SMTCs are overlapped by the associated MG1, the CSSF is calculated using the outside gap method. Taking the DRX cycle without configuration as an example, the measurement period is max(Tthr, ceil (Nsample×Kp)×SMTC period)×CSSF_outside MG1.

Optionally, in a case where none of the measurement timing windows are overlapped by remaining MGs of the plurality of MGs except the fourth MGs, a first scaling factor Kp in the relevant parameters for measurement conducted outside the fourth MGs is determined based on a period of the first MG. For example, when only part of the SMTCs are overlapped by the associated MG1 and are not overlapped by other MGs, Kp=1/(1−(SMTC period/MGRP1))

Optionally, in a case where part of the measurement timing windows are overlapped by the remaining MGs of the plurality of MGs except the fourth MGs, a first scaling factor Kp in the relevant parameters for measurement conducted outside the fourth MGs is determined according to a positional relationship between the fourth MGs and the remaining MGs.

For example, when part of SMTCs are overlapped by MG1 and MG2, and MG1 and MG2 do not overlap (it is necessary to ensure that some SMTCs is outside the two types of MGs, for example, when the two MG periods are different, SMTC period<min (MGRP1, MGRP2), when the two periods are the same, 2*SMTC period<MGRP1=MGRP2), Kp=1/(1−(SMTC period/MGRP1)−(SMTC period/MGRP2)).

When part SMTCs are overlapped by MG1 and MG2, and MG1 and MG2 partially or completely overlap (it is also necessary to ensure that some SMTCs are outside the two types of MGs), Kp=1/(1−(SMTC period/Min (MGRP1, MGRP2)).

Example 2: the determining, by the terminal device, the measurement period of the first frequency point and/or the first MO based on the positional relationship between the at least some MGs of the plurality of MGs and the measurement timing windows of the first frequency point and/or the first MO includes:
determining, by the terminal device, the measurement period of the first frequency point and/or the first MO based on relevant parameters for measurement conducted within the fourth MGs in a case where part of the measurement timing windows of the first frequency point and/or the first MO are overlapped by the fourth MGs.

The following exemplary methods can be selected for implementation.

Example 2-1: in a case that the fourth MGs do not overlap with other MGs in the plurality of MGs except the fourth MGs, the first scaling factor Kp in the relevant parameters for measurement conducted within the fourth MGs is a preset value.

For example, when MG1 has no conflict with other MGs, taking the DRX cycle as an example, the measurement period is max(Tthr, ceil (Nsample×Kp)×SMTC period)× CSSF_MG1, Kp=MGRP1/SMTC period. Since Kp1×SMTC period=MGRP1, the measurement period may be approximately equivalent to be measured based on the period MGRP1 of MG1. i.e., max(Tthr, Nsample×MGRP1)×CSSF_MG1.

### Example 2-2

Optionally, in a case where the fourth MGs overlap with remaining MGs of the plurality of MGs except the fourth MGs, if a priority of the fourth MGs is higher than priorities of the remaining MGs, a first scaling factor Kp in the relevant parameters for measurement conducted within the fourth MGs is determined based on a period of the fourth MGs.

For example, when MG1 conflicts with other MGs, if the associated MG1 has the highest priority, the measurement period is max(Tthr, ceil (Nsample×Kp)×SMTC period)×CSSF_MG1, Kp=MGRP1/SMTC period.

Optionally, the determining, by the terminal device, the measurement period of the first frequency point and/or the first MO based on the relevant parameters for measurement conducted within the fourth MGs includes:

determining, by the terminal device, the measurement period of the first frequency point and/or the first MO based on the a third scaling factor and relevant parameters for measurement conducted within the fourth MGs Kgap in response that a priority of the fourth MGs is lower than priorities of the remaining MGs, in a case where the fourth MGs overlap with the remaining MGs; where the third scaling factor is determined based on ratios between periods of the remaining MGs and a period of the fourth MGs, and a first scaling factor in the relevant parameters for measurement conducted within the fourth MGs is determined based on the period of the fourth MGs.

For example, when MG1 conflicts with other MGs, if the associated MG1 has a low priority, the measurement period is max(Tthr, ceil (Nsample×Kp)×SMTC period)×CSSF_MG1*Kgap, where the third scaling factor Kgap represents a scaling factor brought by an MG1 occasion discarded due to conflict with other MGs, Kgap=MGRP2/MGRP1; Kp=MGRP1/SMTC period.

Example 2-3: the determining, by the terminal device, the measurement period of the first frequency point and/or the first MO based on the relevant parameters for measurement conducted within the fourth MGs includes:
determining, by the terminal device, the measurement period of the first frequency point and/or the first MO based on the relevant parameters for measurement conducted within the fourth MGs and a fourth scaling factor in a case where the fourth MGs overlap with remaining MGs of the plurality of MGs except the fourth MGs; where the fourth scaling factor is determined based on a sharing ratio configured by a network device.

For example, when MG1 conflicts with other MGs, if gap sharing method is adopted, max(Tthr, ceil (Nsample×Kp)×SMTC period)×CSSF_MG1*Kgap, where the fourth scaling factor Kgap can be calculated with gap sharing parameters configured by the network, for example, when the MG1 sharing ratio is 30%, Kgap=100/30, Kp=MGRP1/SMTC period.

### Embodiment 3

This embodiment provides an exemplary implementation that the terminal device determines the measurement period of the first frequency point and/or the first MO in a case where the first frequency point and/or the first MO requires MGs, and the network does not configure MGs associated with the first frequency point and/or the first MO.

In this embodiment, an exemplary implementation is that the terminal device first determines the third MGs used to measure the first frequency point and/or the first MO, and then determines the measurement period of the first frequency point and/or the first MO based the positional relationship between the third MGs and other MGs in the plurality of MGs except a third MG.

Herein there are many ways to determine the third MG. For example, the third MGs are determined based on periods of respective MGs of the plurality of MGs, a quantity of frequency points and/or MOs associated with the respective MGs, priorities of the respective MGs, a third sharing factor of the respective MGs, or a positional relationship between the respective MGs and the measurement timing windows.

For example, the selection is based on the configuration information of MG, for example, select a smaller/larger MGRP, the smaller (the corresponding calculated CSSF will be smaller)/more quantity of frequency points/MOs associated with the MG, or the Higher/lower MG priority, larger/smaller MG sharing ratio is selected.

For another example, the selection is based on the relationship between SMTC and MG, such as selecting MGs with more SMTC occasions overlapping with the MGs within a fixed duration.

The specific measurement period determination method can be set according to the following different cases.

Case 1: the third MGs do not overlap with other MGs.

Specifically, the determining, by the terminal device, the measurement period of the first frequency point and/or the first MO based on the positional relationship between the third MGs and remaining MGs of the plurality of MGs except the third MGs includes:

determining, by the terminal device, the measurement period of the first frequency point and/or the first MO based on relevant parameters for measurement conducted within the third MGs in a case where the third MGs do not overlap with the remaining MGs.

For example, when MG1 does not conflict with other MGs (and there is no gap cancel mechanism that will cancel certain occasions of MG1, if so, you need to use the method of Case 2 or Case 3 is required to adopted to use Kgap to increase the measurement period), and when there is no configured DRX cycle, the measurement period is Max (Tthr, Nsample*max (MGRP1, SMTC period))*CSSF_MG1; when DRX cycle<320 ms is configuring, the measurement period is Max (Tthr, (1.5*Nsample)*Max (MGRP, SMTC period, DRX cycle))*CSSF_MG1, and so on, which will not be repeated herein.

Case 2: the third MGs overlap with other MGs, and priorities of respective MGs are configured.

Optionally, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on relevant parameters for measurement conducted within the third MGs in response that a priority of the third MGs is higher than priorities of the other MGs, in a case where the third MGs overlap with the other MGs.

For details, please refer to the example in case 1.

Optionally, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on the relevant parameters for measurement conducted within the third MGs and a fifth scaling factor in response that a priority of the third MGs is lower than priorities of the remaining MGs, in a case where the third MGs overlap with the remaining MGs; where the fifth scaling factor is determined based on ratios between periods of the remaining MGs and a period of the third MG.

For example, if the associated MG1 has a low priority, the fifth scaling factor Kgap needs to be added based on case 1, and the measurement period is max(Tthr, Nsample*max (MGRP1, SMTC period))*CSSF_MG1*Kgap, where Kgap represents a scaling factor brought by an MG1 occasion discarded due to conflict with other MGs, Kgap=MGRP2/MGRP1.

Case 3: the third MGs overlap with other MGs, and priorities of respective MGs are not configured.

Specifically, the determining, by the terminal device, the measurement period of the first frequency point and/or the first MO based on the positional relationship between the third MGs and remaining MGs of the plurality of MGs except the third MGs includes:
determining the measurement period of the first frequency point and/or the first MO based on relevant parameters for measurement conducted within the third MGs and a sixth scaling factor in a case where the third MGs overlap with the other MGs; where the sixth scaling factor is determined based on a sharing ratio of the network device configuration.

For example, when MG1 conflicts with other MGs, if gap sharing method is adopted, the measurement period is max(Tthr, Nsample*max(MGRP1, SMTC period)) *CSSF_MG1*Kgap, where the sixth scaling factor Kgap can be calculated with a gap sharing parameter configured by the network, for example, when MG1 sharing ratio is 30%, Kgap=100/30.

Optionally, upon calculating the CSSF of other frequency points/MOs associated with the selected MG, this frequency point/MO needs to be taken into account. Unselected MGs do not take this frequency point/MO into consideration.

In this embodiment, another exemplary implementation is that the terminal device determines the measurement period of the first frequency point and/or the first MO based on the maximum value or the minimum value of the measurement periods corresponding to respective MGs.

For example, the measurement periods are calculated based on respective MGs (the UE is allowed to measure within any one MG, but considers the maximum value upon determining the measurement period), and then selects the maximum value. Take the DRX cycle not configured as an example,
the measurement period based on MG1 is Max (Tthr, Nsample*max(MGRP1, SMTC period))*CSSF_MG1;
the measurement period based on MG2 is Max (Tthr, Nsample*max(MGRP2, SMTC period))*CSSF_MG2;
the maximum value of the measurement periods is selected.

Optionally, upon calculating CSSFs of other frequency points/MOs associated with MG1 or MG2, the frequency point/MO needs to be taken into account.

### Embodiment 4

This embodiment provides an exemplary implementation that the terminal device determines the measurement period of the first frequency point and/or the first MO in a case where the first frequency point and/or the first MO requires MGs, and the network configures MGs associated with the first frequency point and/or the first MO.

Specifically, since the associated MGs are configured and measurement needs to be performed within MG, the first frequency point and/or the first MO can only be measured based on the associated MGs, and the configuration needs to ensure that the frequency point/MO can be associated with an MG.

In this embodiment, the third MGs used to measure the first frequency point and/or the first MO are MGs configured by the network device and associated with the first frequency point and/or the first MO. The terminal device determines the measurement period of the first frequency point and/or the first MO based on the method for measurement conducted within the third MG. For details, reference may be made to the specific measurement period determination method shown in Embodiment 3, that is, the content of cases 1-3 in Embodiment 3, which will not be repeated herein.

The specific settings and implementation methods of the embodiments of the present application have been described from different angles through multiple embodiments. Using at least one of the above embodiments, when a terminal device determines a measurement period of a frequency point and/or a MO in a case where multiple MGs are supported, a positional relationship between measurement timing windows of the frequency point and/or the MO and some or all of the MGs, and/or a positional relationship between an MG used to measure the frequency point and/or the MO and the remaining MGs is considered, thereby ensuring a quantity of samples within a measurement period and conducive to improving the accuracy of measurement.

Corresponding to the processing method of at least one embodiment described above, the embodiments of the present application further provide a terminal device 100. Referring to FIG. 7, the terminal device 100 includes:
a first processing module 110, configured to determine a measurement period of a first frequency point and/or a first MO based on a first positional relationship;
where the first positional relationship includes a positional relationship between at least some MGs of a plurality of MGs that are configured and measurement timing windows of the first frequency point and/or the first MO, and/or a positional relationship between third MGs of the plurality of MGs that are used to measure the first frequency point and/or the first MO and remaining MGs of the plurality of MGs except the third MG.

Exemplarily, as shown in FIG. 8, the first processing module 110 includes:
a first period determining unit 111, configured to determine the measurement period of the first frequency point and/or the first MO based on the positional relationship between the at least some MGs of the plurality of MGs and the measurement timing windows of the first frequency point and/or the first MO in response that MGs are not required to be used in a measurement of the first frequency point and/or the first MO.

Herein, in a case where MGs associated with the first frequency point and/or the first MO are not configured, the at least some MGs include each MG of the plurality of MGs.

Exemplarily, the first period determining unit 111 is configured to:
determine the measurement period of the first frequency point and/or the first MO based on relevant parameters for measurement conducted outside the plurality of MGs in a case where none of the measurement timing windows of the first frequency point and/or the first MO are overlapped by respective MGs of the plurality of MGs.

Optionally, the first period determining unit 111 is configured to:
determine the measurement period of the first frequency point and/or the first MO based on relevant parameters for measurement conducted within first MGs of the plurality of MGs in a case where all of the measurement timing windows of the first frequency point and/or the first MO are overlapped by the first MGs and none of the measurement timing windows of the first frequency point and/or the first MO are overlapped by second MGs of the plurality of MGs.

Exemplarily, the first period determining unit 111 is configured to:
determine the measurement period of the first frequency point and/or the first MO based on relevant parameters for measurement conducted within first MGs of the plurality of MGs or relevant parameters for measurement conducted outside the first MGs in a case where part of the measurement timing windows of the first frequency point and/or the first MO partially are overlapped by the first MGs and does not overlap with second MGs of the plurality of MGs.

Optionally, the first scaling factor in the relevant parameters for measurement conducted within the first MGs is determined based on a period of the first MG.

Optionally, the first scaling factor in the relevant parameters for measurement conducted outside the first MGs is determined based on a period of the first MG.

Exemplarily, the first period determining unit 111 is configured to:
determine the measurement period of the first frequency point and/or the first MO based on relevant parameters for measurement conducted within the first MGs of the plurality of MGs and/or relevant parameters for measurement conducted outside second MGs in response that priorities of the plurality of MGs are uncertain or the same, in a case where all of the measurement timing windows of the first frequency point and/or the first MO are overlapped by the first MGs and part of the measurement timing windows of the first frequency point and/or the first MO are overlapped by the second MGs of the plurality of MGs.

Optionally, the determining the measurement period of the first frequency point and/or the first MO based on the relevant parameters for measurement conducted within the first MGs and/or the relevant parameters for measurement conducted outside the second MGs includes:
determining the measurement period of the first frequency point and/or the first MO based on a maximum value or a minimum value of a first measurement period and a second measurement period; where the first measurement period is determined based on the relevant parameters for measurement conducted within the first MGs, and the second measurement period is determined based on the relevant parameters for measurement conducted outside the second MG.

Exemplarily, the first period determining unit 111 is configured to:
determine the measurement period of the first frequency point and/or the first MO based on relevant parameters for measurement conducted within first MGs of the plurality of MGs in response that a priority of the first MGs is higher than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs.

Exemplarily, the first period determining unit 111 is configured to:
determine the measurement period of the first frequency point and/or the first MO based on a maximum value or a minimum value of a third measurement period and a fourth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the third measurement period is determined based on relevant parameters for measurement conducted within the first MGs, and the fourth is determined based on relevant parameters for measurement conducted within the second MG.

Exemplarily, the first scaling factor in the relevant parameters for measurement conducted within the first MGs is a preset value or determined based on a period of the second MG.

Exemplarily, the first scaling factor in the relevant parameters for measurement conducted within the second MGs is a preset value or determined based on a period of the second MG.

Exemplarily, the first period determining unit 111 is configured to:
determine the measurement period of the first frequency point and/or the first MO based on a maximum value or a minimum value of a fifth measurement period and a sixth measurement period in response that a priority of the first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the fifth measurement period is determined based on relevant parameters for measurement conducted within the first MGs, and the sixth measurement period is determined based on relevant parameters for measurement conducted outside the second MG.

Exemplarily, the first period determining unit 111 is configured to:
determine the measurement period of the first frequency point and/or the first MO based on a maximum value or a minimum value of a seventh measurement period and an eighth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the seventh measurement period is determined based on relevant parameters for measurement conducted outside the first MGs, and the eighth measurement period is determined based on relevant parameters for measurement conducted outside the second MG.

Exemplarily, the first period determining unit 111 is configured to:
determine the measurement period of the first frequency point and/or the first MO based on a maximum value or a minimum value of a ninth measurement period and a tenth measurement period or a sum of the ninth measurement period and the tenth measurement period in response that a priority of first MGs of the plurality of MGs is lower than a priority of second MGs of the plurality of MGs, in a case where all of the measurement timing windows of the first frequency point and/or the first MO are overlapped by the first MGs and part of the measurement timing windows of the first frequency point and/or the first MO are overlapped by the second MGs;
where the ninth measurement period is determined based on relevant parameters for measurement conducted outside the first MGs and the first ratio corresponding to the first MGs, and the tenth measurement period is determined based on relevant parameters for measurement conducted outside the second MGs and a second ratio corresponding to the second MG.

Optionally, the first ratio and the second ratio are determined based on the relevant parameters for measurement conducted outside the first MGs and the relevant parameters for measurement conducted outside the second MG.

Optionally, the first ratio and the second ratio are determined based on a first sharing factor configured by a network device.

Optionally, the first period determining unit 111 is configured to:
determine the measurement period of the first frequency point and/or the first MO based on relevant parameters for measurement conducted outside the plurality of MGs in a case where part of the measurement timing windows of the first frequency point and/or the first MO are overlapped by respective MGs of the plurality of MGs, and the measurement timing windows include a part of the measurement timing windows that are not overlapped by any one of the plurality of MGs.

Optionally, the first scaling factor in the relevant parameters for measurement conducted outside the plurality of MGs is determined based on a positional relationship between the plurality of MGs.

Optionally, in a case where the plurality of MGs does not overlap with each other, the first scaling factor is determined based on periods of the respective MGs.

Optionally, in a case where the plurality of MGs overlaps, the first scaling factor is determined based on a minimum value in periods of the respective MGs.

Exemplarily, determining the measurement period of the first frequency point and/or the first MO based on the relevant parameters for measurement conducted outside the plurality of MGs includes:
determining the measurement period of the first frequency point and/or the first MO based on the relevant parameters for measurement conducted outside the plurality of MGs in a case where priorities of the plurality of MGs are uncertain or the priorities of the plurality of MGs are different or the same.

Optionally, the first period determining unit 111 is configured to:
determine third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

Optionally, the third MGs are determined based on a preset rule or priorities of the respective MGs of the plurality of MGs.

Exemplarily, the first period determining unit 111 is configured to:
determine the measurement period of the first frequency point and/or the first MO based on relevant parameters for measurement conducted within respective MGs of the plurality of MGs in a case where part of the measurement timing windows of the first frequency point and/or the first MO are overlapped by the respective MGs of the plurality of MGs, and the measurement timing windows include a part of measurement timing windows that are not overlapped by any one of the plurality of MGs.

Optionally, the determining the measurement period of the first frequency point and/or the first MO based on the relevant parameters for measurement conducted within the respective MGs of the plurality of MGs includes:
determining the measurement period of the first frequency point and/or the first MO based on a maximum value or a minimum value of CSSFs measured within the respective MGs of the plurality of MGs.

Exemplarily, the determining the measurement period of the first frequency point and/or the first MO based on the relevant parameters for measurement conducted within the respective MGs of the plurality of MGs includes:
determining measurement periods corresponding to respective MGs of the plurality of MGs based on relevant parameters for measurement conducted within the respective MGs;
determining the measurement period of the first frequency point and/or the first MO based on a maximum value or a minimum value of the measurement periods corresponding to the respective MGs of the plurality of MGs.

Exemplarily, the first period determining unit 111 is configured to:
determine third MGs used to measure the first frequency point and/or the first MO, of the plurality of MGs, and determining, by the terminal device, the measurement period of the first frequency point and/or the first MO based on relevant parameters for measurement conducted within the third MGs in a case where part of the measurement timing windows of the first frequency point and/or the first MO are overlapped by respective MGs of the plurality of MGs, and the measurement timing windows do not include a part of measurement timing windows that are not overlapped by any one of the plurality of MGs.

Optionally, the third MGs are determined based on a preset rule or priorities of the respective MGs of the plurality of MGs.

Exemplarily, the first period determining unit 111 is configured to:
determine the measurement period of the first frequency point and/or the first MO based on CSSFs corresponding to measurements conducted within respective MGs of the plurality of MGs in a case where all of the measurement timing windows of the first frequency point and/or the first MO are overlapped by the respective MGs of the plurality of MGs.

Optionally, the determining the measurement period of the first frequency point and/or the first MO based on the CSSFs corresponding to measurements conducted within the respective MGs of the plurality of MGs includes:
determining the measurement period of the first frequency point and/or the first MO based on a maximum value or a minimum value of the CSSFs corresponding to measurements conducted within the respective MGs of the plurality of MGs.

Exemplarily, the determining the measurement period of the first frequency point and/or the first MO based on the CSSFs corresponding to measurements conducted within the respective MGs of the plurality of MGs includes:
determining second scaling factors corresponding to the respective MGs of the plurality of MGs, based on the CSSFs corresponding to measurements conducted within the respective MGs of the plurality of MGs and second sharing factors corresponding to the respective MGs of the plurality of MGs;
determining the measurement period of second the first frequency point and/or the first MO based on a maximum value or a minimum value of the second scaling factors corresponding to the respective MGs of the plurality of MGs.

Exemplarily, the first period determining unit 111 is configured to:
determine third MGs used to measure the first frequency point and/or the first MO, of the plurality of MGs and determining, by the terminal device, the measurement period of the first frequency point and/or the first MO based on relevant parameters for measurement conducted within the third MGs in a case where all of the measurement timing windows of the first frequency point and/or the first MO are overlapped by respective MGs of the plurality of MGs.

Optionally, the third MGs are determined based on a preset rule or priorities of the respective MGs of the plurality of MGs.

Exemplarily, the at least some MGs include fourth MGs configured by a network device and associated with the first frequency point and/or the first MO.

Exemplarily, the first period determining unit 111 is configured to:
determine the measurement period of the first frequency point and/or the first MO based on relevant parameters for measurement conducted outside the fourth MGs in a case where none of the measurement timing windows of the first frequency point and/or the first MO are overlapped by the fourth MGs.

Optionally, in a case where none of the measurement timing windows are overlapped by remaining MGs of the plurality of MGs except the fourth MGs, a first scaling factor in the relevant parameters for measurement conducted outside the fourth MGs is a preset value.

Exemplarily, in a case where part of the measurement timing windows are overlapped by remaining MGs of the plurality of MGs except the fourth MGs, a first scaling factor in the relevant parameters for measurement conducted outside the fourth MGs is determined based on periods of the remaining MGs.

Exemplarily, the first period determining unit 111 is configured to:
determine the measurement period of the first frequency point and/or the first MO based on relevant parameters for measurement conducted within the fourth MGs in a case where all of the measurement timing windows of the first frequency point and/or the first MO are overlapped by the fourth MGs.

Exemplarily, in a case where the fourth MGs do not overlap with remaining MGs of the plurality of MGs except the fourth MGs, a first scaling factor in the relevant parameters for measurement conducted within the fourth MGs is a preset value.

Exemplarily, determining the measurement period of the first frequency point and/or the first MO based on the relevant parameters for measurement conducted within the fourth MGs includes:
determining the measurement period of the first frequency point and/or the first MO based on the relevant parameters for measurement conducted within the fourth MGs in response that a priority of the fourth MGs is higher than priorities of the remaining MGs of the plurality of MGs except the fourth MGs, in a case where the fourth MGs overlap with the remaining MGs.

Exemplarily, determining the measurement period of the first frequency point and/or the first MO based on the relevant parameters for measurement conducted within the fourth MGs includes:
determining the measurement period of the first frequency point and/or the first MO based on the relevant parameters for measurement conducted within the fourth MGs and a third scaling factor in response that a priority of the fourth MGs is lower than priorities of remaining MGs of the plurality of MGs except the fourth MG, in a case where the fourth MGs overlap with the remaining MGs, where the third scaling factor is determined based on ratios between periods of the remaining MGs and a period of the fourth MGs.

Exemplarily, determining the measurement period of the first frequency point and/or the first MO based on the relevant parameters for measurement conducted within the fourth MGs includes:
determining the measurement period of the first frequency point and/or the first MO based on the relevant parameters for measurement conducted within the fourth MGs and a fourth scaling factor in a case where the fourth MGs overlap with remaining MGs of the plurality of MGs except the fourth MGs; where the fourth scaling factor is determined based on a sharing ratio configured by a network device.

Optionally, the first period determining unit 111 is configured to:
determine the measurement period of the first frequency point and/or the first MO based on relevant parameters for measurement conducted outside the fourth MGs in a case where part of the measurement timing windows of the first frequency point and/or the first MO are overlapped by the fourth MGs.

Optionally, in a case where none of the measurement timing windows are overlapped by remaining MGs of the plurality of MGs except the fourth MGs, a first scaling factor in the relevant parameters for measurement conducted outside the fourth MGs is determined based on a period of the first MG.

Optionally, in a case where part of the measurement timing windows are overlapped by the remaining MGs of the plurality of MGs except the fourth MGs, a first scaling factor in the relevant parameters for measurement conducted outside the fourth MGs is determined according to a positional relationship between the fourth MGs and the remaining MGs.

Exemplarily, the first period determining unit 111 is configured to:
determine the measurement period of the first frequency point and/or the first MO based on relevant parameters for measurement conducted within the fourth MGs in a case where part of the measurement timing windows of the first frequency point and/or the first MO are overlapped by the fourth MGs.

Exemplarily, in a case where the fourth MGs do not overlap with remaining MGs of the plurality of MGs except the fourth MGs, a first scaling factor in the relevant parameters for measurement conducted within the fourth MGs is a preset value.

Exemplarily, in a case where the fourth MGs overlap with remaining MGs of the plurality of MGs except the fourth MGs, if a priority of the fourth MGs is higher than priorities of the remaining MGs, a first scaling factor in the relevant parameters for measurement conducted within the fourth MGs is determined based on a period of the fourth MG.

Exemplarily, determining the measurement period of the first frequency point and/or the first MO based on the relevant parameters for measurement conducted within the fourth MGs includes:
determining the measurement period of the first frequency point and/or the first MO based on a third scaling factor and relevant parameters for measurement conducted within the fourth MGs in response that a priority of the fourth MGs is less than priorities of the remaining MGs, in a case where the fourth MGs overlap with the remaining MGs, where the third scaling factor is determined based on ratios between periods of the remaining MGs and a period of the fourth MGs, and a first scaling factor in the relevant parameters for measurement conducted within the fourth MGs is determined based on the period of the fourth MGs.

Optionally, determining the measurement period of the first frequency point and/or the first MO based on the relevant parameters for measurement conducted within the fourth MGs includes:
determining the measurement period of the first frequency point and/or the first MO based on the relevant parameters for measurement conducted within the fourth MGs and a fourth scaling factor in a case where the fourth MGs overlap with remaining MGs of the plurality of MGs except the fourth MGs; where the fourth scaling factor is determined based on a sharing ratio configured by a network device.

Exemplarily, as shown in FIG. 8, the first processing module 110 further includes:
a second period determining unit 112, configured to determine the measurement period of the first frequency point and/or the first MO based on the positional relationship between the third MGs and remaining MGs of the plurality of MGs except the third MGs in response that MGs are required to be used in a measurement of the first frequency point and/or the first MO.

Optionally, the third MGs are determined based on periods of respective MGs of the plurality of MGs, a quantity of frequency points and/or MOs associated with the respective MGs, priorities of the respective MGs, a third sharing factor of the respective MGs, or a positional relationship between the respective MGs and the measurement timing windows.

Optionally, the third MGs are MGs configured by a network device and associated with the first frequency point and/or the first MO.

Exemplarily, the second period determining unit 112 is configured to:
determine the measurement period of the first frequency point and/or the first MO based on relevant parameters for measurement conducted within the third MGs in a case where the third MGs do not overlap with the remaining MGs.

Exemplarily, the second period determining unit 112 is further configured to:
determine the measurement period of the first frequency point and/or the first MO based on relevant parameters for measurement conducted within the third MGs in response that a priority of the third MGs is higher than priorities of the remaining MGs, in a case where the third MGs overlap with the remaining MGs.

Optionally, the second period determining unit 112 is further configured to:
determine the measurement period of the first frequency point and/or the first MO based on a fifth scaling factor and relevant parameters for measurement conducted within the third MGs in response that a priority of the third MGs is lower than priorities of the remaining MGs, in a case where the third MGs overlap with the remaining MGs; where the fifth scaling factor is determined based on ratios between periods of the remaining MGs and a period of the third MGs.

Exemplarily, the second period determining unit 112 is further configured to:
determine the measurement period of the first frequency point and/or the first MO based on relevant parameters for measurement conducted within the third MGs and a sixth scaling factor in a case where the third MGs overlap with the other MGs; where the sixth scaling factor is determined based on a sharing ratio of the network device configuration.

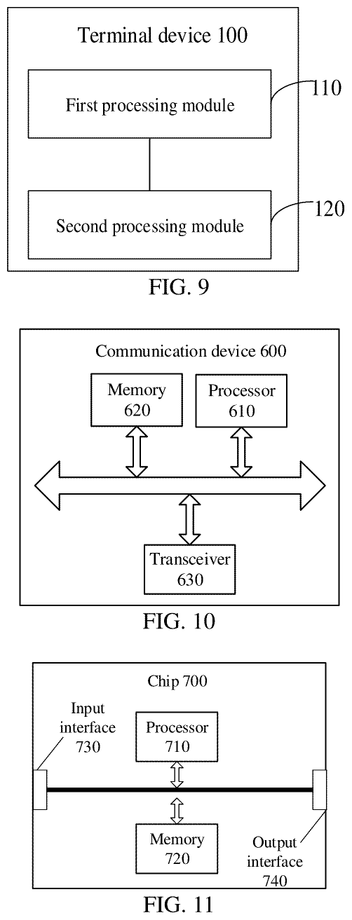

Exemplarily, as shown in FIG. 9, the terminal device further includes a second processing module 120, where the second processing module 120 is configured to:
determining, by the terminal device, measurement periods corresponding to respective MGs of the plurality of MGs based on relevant parameters for measurement conducted within the respective MGs in response that MGs are required to be used in a measurement of the first frequency point and/or the first MO;
determining, by the terminal device, the measurement period of the first frequency point and/or the first MO based on a maximum value or a minimum value of the measurement periods corresponding to the respective MGs of the plurality of MGs.

Exemplarily, for each MG of the plurality of MGs, a CSSF for measurement conducted within the MG is related to at least one of:
a frequency point and/or an MO associated with the MG; or
a frequency point and/or an MO whose measurement periods are determined based on relevant parameters for measurement conducted within the MG.

The terminal device 100 in the embodiments of the present application can realize the corresponding functions of the terminal device in the aforementioned method embodiments. The corresponding processes, functions, implementation methods and beneficial effects of each module (sub-module, unit or component, etc.) in the terminal device 100. Please refer to the corresponding description in the above method embodiments, and will not be repeated herein. It should be noted that the functions described for each module (sub-module, unit or component, etc.) in the terminal device 100 in the embodiments of the present application can be implemented by different modules (sub-module, unit or component, etc.), or can be implemented by the same module (sub-module, unit or component, etc.). For example, the first sending module and the second sending module can be different modules, or the first sending module and the second sending module can be the same module, both of which can realize corresponding functions in the embodiments of the present application. In addition, the communication module in the embodiments of the present application can be implemented by the transceiver of the device, and some or all of the remaining modules can be implemented by the processor of the device.

FIG. 10 is a schematic block diagram of a communication device 600 according to the embodiments of the present application. The communication device 600 includes a processor 610. The processor 610 can call and run a computer program from the memory to implement the methods in the embodiments of the present application.

Optionally, the communication device 600 further includes a memory 620. The processor 610 can call and run a computer program from the memory 620 to implement the methods in the embodiments of the present application.

The memory 620 may be a separate device independent of the processor 610, or may be integrated into the processor 610.

Optionally, the communication device 600 may further include a transceiver 630. The processor 610 can control the transceiver 630 to communicate with other devices, specifically, to transmit information or data to other devices or to receive information or data transmitted by other devices.

The transceiver 630 may include a transmitter and a receiver. The transceiver 630 may further include an antenna, where one or more antennas can be provided.

Optionally, the communication device 600 can be a network device of the embodiments of this application, and the communication device 600 can implement the corresponding processes implemented by the network device in various methods of the embodiments of this application, which will not be repeated herein for brevity.

Optionally, the communication device 600 may be a terminal device in the embodiments of the present application, and the communication device 600 may implement the corresponding processes implemented by the terminal device in each method of the embodiments of the present application. For the sake of brevity, details will not be repeated herein.

FIG. 11 is a schematic structural diagram of a chip 700 according to the embodiments of the present application. The chip 700 includes a processor 710. The processor 710 can call and run computer programs stored in a memory to perform the methods in the embodiments of the present application.

Optionally, the chip 700 further includes a memory 720. The processor 710 can call and run the computer programs stored in the memory 720 to perform the methods in the embodiments of the present application.

The memory 720 may be a separate device independent of the processor 710, or may be integrated into the processor 710.

Optionally, the chip 700 may further include an input interface 730. The processor 710 can control the input interface 730 to communicate with other devices or chips, specifically, to acquire information or data transmitted by other devices or chips.

Optionally, the chip 700 may further include an output interface 740. The processor 710 can control the output interface 740 to communicate with other devices or chips, specifically, to output information or data to other devices or chips.

Optionally, the chip can be applied to the network device in the embodiments of the present application, and the chip can implement the corresponding processes implemented by the network device in the various methods of the embodiments of the present application. For the sake of brevity, the details will not be repeated herein.

Optionally, the chip can be applied to the terminal device in the embodiments of the present application, and the chip can implement the corresponding processes implemented by the terminal device in each method of the embodiments of the present application. For the sake of brevity, the details will not be repeated herein.

It should be understood that the chips mentioned in the embodiments of this application can also be called system-level chip, system chip, chip system or system-on-chip chip.

The processor mentioned above can be a general-purpose processor, a digital signal processor (digital signal processor, DSP), a field programmable gate array (field programmable gate array, FPGA), an application specific integrated circuit (application specific integrated circuit, ASIC) or other programmable logic devices, transistor logic devices, discrete hardware components, etc. The above-mentioned general processor may be a microprocessor or any conventional processor.

The memory mentioned above may be a volatile memory or a non-volatile memory, or may include both volatile and non-volatile memories. The non-volatile memory may be a read-only memory (read-only memory, ROM), a programmable read-only memory (programmable ROM, PROM), an erasable programmable read-only memory (erasable PROM, EPROM), or an electrically erasable programmable read-only memory (electrically EPROM, EEPROM) or a flash memory. Volatile memory may be random access memory (random access memory, RAM).

It should be understood that the above-mentioned memory is an exemplary but not restrictive description. For example, the memory in the embodiments of this application can also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synch link dynamic random access memory (synch link DRAM, SLDRAM), direct rambus random access memory (Direct Rambus RAM, DR RAM) etc. In other words, the memory in the embodiments of this application is intended to include, but is not limited to, these and any other suitable types of memories.

The above embodiments may be implemented in whole or in part through software, hardware, firmware, or any combination thereof. When the above embodiments are implemented by using a software, the software may be implemented in a form of a computer program product in whole or in part. The computer program product includes one or more computer instructions. When the computer instructions are loaded and executed on a computer, all or some of the processes or functions of the implementations of the present application are performed. The computer may be a general-purpose computer, a special-purpose computer, a computer network, or any other programmable apparatus. The computer instructions can be stored in a non-transitory computer-readable storage medium, or transmitted from one non-transitory computer-readable storage medium to another non-transitory computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (Digital Subscriber Line, DSL), or the like. The wireless manner can be, for example, infrared, wireless, microwave, or the like. The non-transitory computer-readable storage medium can be any computer accessible usable-medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (Solid State Disk, SSD)).

It should be understood that in each embodiment of the present application, the sequence numbers of the above-mentioned processes do not mean the order of execution, and the order of execution of each process should be determined by its functions and internal logic, and should not constitute any limitation on the implementing process of the embodiment of the present application.

Those skilled in the art can clearly understand that for the convenience and brevity of the description, specific working processes of a system, an apparatus and a unit described above can refer to the corresponding processes in the foregoing method embodiments, and details are not described herein again.

In the description of this specification, referring to the descriptions of the terms “one embodiment”, “some embodiments”, “examples”, “specific examples” or “some examples” mean that the specific features, structures, material or characteristics described in combination with this embodiment or example are included in at least one embodiment or example of the present invention. Furthermore, the described specific features, structures, material or characteristics may be combined in any one or more embodiments or examples in a suitable manner. In addition, those skilled in the art can combine and assembly different embodiments or examples described in this description and the features of different embodiments or examples without contradicting each other.

In addition, terms such as “first” and “second” are only used for descriptive purposes, and are not to be construed as indicating or implying the relative importance or implicitly indicating the quantity of indicated technical features. Thus, features defined by “first” or “second” may explicitly or implicitly include one or more of these features. In the description of the present invention, term “a plurality of” or “the plurality of” means two or more unless otherwise specified.

The foregoing descriptions are merely specific implementation manners of the preset application, but the protection scope of the preset application is not limited thereto; Any person skilled in the art could readily conceive of changes or replacements within the technical scope of the preset application, which shall all be included in the protection scope of the preset application. Therefore, the protection scope of the present application shall be subject to the protection scope of the claims.

What is claimed is:

1. A method for determining a measurement period, comprising:
determining, by a terminal device, a measurement period of a first frequency point and/or a first MO based on a first positional relationship;
wherein the first positional relationship comprises a positional relationship between at least some MGs of a plurality of MGs that are configured and measurement timing windows of the first frequency point and/or the first MO, and/or a positional relationship between third MGs of the plurality of MGs that are used to measure the first frequency point and/or the first MO and remaining MGs of the plurality of MGs except the third MGs.

2. The method according to claim 1, wherein the determining, by the terminal device, the measurement period of the first frequency point and/or the first MO based on the first positional relationship comprises:
determining, by the terminal device, the measurement period of the first frequency point and/or the first MO based on the positional relationship between the at least some MGs of the plurality of MGs and the measurement timing windows of the first frequency point and/or the first MO in response that MGs are not required to be used in a measurement of the first frequency point and/or the first MO.

3. The method according to claim 2, wherein in a case where MGs associated with the first frequency point and/or the first MO are not configured, the at least some MGs comprise each MG of the plurality of MGs.

4. The method according to claim 3, wherein the determining, by the terminal device, the measurement period of the first frequency point and/or the first MO based on the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted outside the plurality of MGs in a case where none of the measurement timing windows of the first frequency point and/or the first MO are overlapped by respective MGs of the plurality of MGs.

5. The method according to claim 3, wherein the determining, by the terminal device, the measurement period of the first frequency point and/or the first MO based on the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted within first MGs of the plurality of MGs in a case where all of the measurement timing windows of the first frequency point and/or the first MO are overlapped by the first MGs and not overlapped by second MGs of the plurality of MGs.

6. The method according to claim 3, wherein the determining, by the terminal device, the measurement period of the first frequency point and/or the first MO based on the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted within first MGs of the plurality of MGs or relevant parameters for measurement conducted outside first MGs in a case where part of the measurement timing windows of the first frequency point and/or the first MO are overlapped by the first MGs and none of the measurement timing windows of the first frequency point and/or the first MO are overlapped by second MGs of the plurality of MGs.

7. The method according to claim 6, wherein a first scaling factor in the relevant parameters for measurement conducted outside the first MGs is determined based on a period of the first MGs.

8. The method according to claim 3, wherein the determining, by the terminal device, the measurement period of the first frequency point and/or the first MO, according to the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted outside the plurality of MGs in a case where part of the measurement timing windows of the first frequency point and/or the first MO are overlapped by respective MGs of the plurality of MGs, and the measurement timing windows include a part of measurement timing windows that are not overlapped by any one of the plurality of MGs.

9. The method according to claim 8, wherein the first scaling factor in the relevant parameters for measurement conducted outside the plurality of MGs is determined based on a positional relationship between the plurality of MGs.

10. The method according to claim 2, wherein the at least some MGs comprise fourth MGs configured by a network device and associated with the first frequency point and/or the first MO.

11. The method according to claim 10, wherein the determining, by the terminal device, the measurement period of the first frequency point and/or the first MO based on the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted outside the fourth MGs in a case where none of the measurement timing windows of the first frequency point and/or the first MO are overlapped by the fourth MGs.

12. The method according to claim 11, wherein in a case where none of the measurement timing windows are overlapped by remaining MGs of the plurality of MGs except the fourth MGs, a first scaling factor in the relevant parameters for measurement conducted outside the fourth MGs is a preset value; or
in a case where part of the measurement timing windows are overlapped by remaining MGs of the plurality of MGs except the fourth MGs, a first scaling factor in the relevant parameters for measurement conducted outside the fourth MGs is determined based on periods of the remaining MGs.

13. The method according to claim 10, wherein the determining, by the terminal device, the measurement period of the first frequency point and/or the first MO based on the positional relationship between the at least some MGs of the plurality of MGs and the measurement timing windows of the first frequency point and/or the first MO comprises:
determining, by the terminal device, the measurement period of the first frequency point and/or the first MO based on relevant parameters for measurement conducted within the fourth MGs in a case where all of the measurement timing windows of the first frequency point and/or the first MO are overlapped by the fourth MGs.

14. The method according to claim 1, wherein the determining, by the terminal device, the measurement period of the first frequency point and/or the first MO based on the first positional relationship comprises:
determining, by the terminal device, the measurement period of the first frequency point and/or the first MO based on the positional relationship between the third MGs and remaining MGs of the plurality of MGs except the third MGs in response that MGs are required to be used in a measurement of the first frequency point and/or the first MO.

15. The method according to claim 14, wherein the third MGs are MGs configured by a network device and associated with the first frequency point and/or the first MO.

16. The method according to claim 14, wherein the determining, by the terminal device, the measurement period of the first frequency point and/or the first MO based on the positional relationship between the third MGs and remaining MGs of the plurality of MGs except the third MGs comprise:
determining, by the terminal device, the measurement period of the first frequency point and/or the first MO based on relevant parameters for measurement conducted within the third MGs in a case where the third MGs do not overlap with the remaining MGs; or
determining the measurement period of the first frequency point and/or the first MO based on relevant parameters for measurement conducted within the third MGs in response that a priority of the third MGs is higher than priorities of the remaining MGs, in a case where the third MGs overlap with the remaining MGs; or
determining the measurement period of the first frequency point and/or the first MO based on a fifth scaling factor and relevant parameters for measurement conducted within the third MGs in response that a priority of the third MGs is lower than priorities of the remaining MGs, in a case where the third MGs overlap with the remaining MGs; wherein the fifth scaling factor is determined based on ratios between periods of the remaining MGs and a period of the third MGs.

17. A terminal device, comprising:
a memory, configured to store a computer program; and
a processor, configured to call and run the computer program stored in the memory to cause the terminal device to perform:
determining a measurement period of a first frequency point and/or a first MO based on a first positional relationship;
wherein the first positional relationship comprises a positional relationship between at least some MGs of a plurality of MGs that are configured and measurement timing windows of the first frequency point and/or the first MO, and/or a positional relationship between third MGs of the plurality of MGs that are used to measure the first frequency point and/or the first MO and remaining MGs of the plurality of MGs except the third MGs.

18. The terminal device according to claim 17, wherein the determining the measurement period of the first frequency point and/or the first MO based on the first positional relationship comprises:
determining the measurement period of the first frequency point and/or the first MO based on the positional relationship between the at least some MGs of the plurality of MGs and the measurement timing windows of the first frequency point and/or the first MO in response that MGs are not required to be used in a measurement of the first frequency point and/or the first MO.

19. The terminal device according to claim 18, wherein in a case where MGs associated with the first frequency point and/or the first MO are not configured, the at least some MGs comprise each MG of the plurality of MGs.

20. A non-transitory computer-readable storage medium configured to store a computer program, wherein
the computer program causes a computer to perform:
determining a measurement period of a first frequency point and/or a first MO based on a first positional relationship;
wherein the first positional relationship comprises a positional relationship between at least some MGs of a plurality of MGs that are configured and measurement timing windows of the first frequency point and/or the first MO, and/or a positional relationship between third MGs of the plurality of MGs that are used to measure the first frequency point and/or the first MO and remaining MGs of the plurality of MGs except the third MGs.
